(19) United States
(12) Patent Application Publication
(10) Pub. No.: US 2016/0019753 A1
(43) Pub. Date: Jan. 21, 2016

(54) METHODS OF ADMINISTERING WAGERING GAMES INVOLVING PAYOUTS FOR EQUALLY-RANKED HANDS

(71) Applicant: Bally Gaming, Inc., Las Vegas, NV (US)

(72) Inventor: Roger M. Snow, Las Vegas, NV (US)

(21) Appl. No.: 14/333,301

(22) Filed: Jul. 16, 2014

(51) Int. Cl. G07F 17/32; A63F 1/00

(52) U.S. Cl. CPC G07F 17/3244; A63F 1/00; G07F 17/3293; A63F 2001/005

(57) ABSTRACT

Methods of administering wagering games may involve accepting a player's ante wager. Cards may be dealt to the player and a dealer and arranged into high and low hands. The ante wager may be collected when one of the high and low player hands is of the same rank as a corresponding one of the high and low dealer hands and the other of the high and low player hands is of a different rank than the corresponding other of the high and low dealer hands. A payout on the ante wager may be paid when each of the high and low player hands is of the same rank as each of the corresponding high and low dealer hands, respectively.

### FIELD

This disclosure relates generally to methods of administering wagering games for casinos and other gaming establishments and related systems and apparatuses. More specifically, disclosed embodiments relate to methods of administering wagering games of pai gow poker against a dealer.

### BACKGROUND

Pai gow poker is a wagering game played in casinos and other gaming establishments. Conventional pai gow poker is frequently characterized by slow play. In addition, many bets placed in conventional pai gow poker result in a push. The house conventionally collects a commission to improve the profitability of pai gow poker, such as, for example, by retaining 5% of all winning bets. Calculating and collecting the commission further slows game play.

Some attempts have been made to maintain the profitability of pai gow poker without the necessity to collect any commission. For example, U.S. patent application Ser. No. 12/618,597, assigned to Bally Gaming, Inc. of Las Vegas, Nev., filed Nov. 13, 2009, for “COMMISSIONLESS PAI GOW WITH DEALER QUALIFICATION,” the disclosure of which is incorporated herein in its entirety by this reference, discloses methods for administering commissionless pai gow poker games. Briefly, the dealer's hand must be of a predetermined rank or higher to continue according to otherwise conventional scoring and payout rules. If the dealer's hand does not achieve the predetermined rank or higher, player bets are paid a fixed odds payout of 1:2.

As another example, U.S. Pat. No. 8,262,450, assigned to Lubin-Jones, LLC of Las Vegas, Nev. filed Jul. 6, 2009 and issued Sep. 11, 2012, for “NON-COMMISSION PAI GOW POKER GAMES, DEVICES, SYSTEMS AND METHODS THEREOF,” the disclosure of which is incorporated herein in its entirety by this reference, discloses additional methods for administering non-commission pai gow poker games. Briefly, the players' ante wagers push when the dealer's high hand (i.e., the five-card hand) is ranked queen high. Players may make an optional side bet, which results in a 50:1 fixed odds payout when the dealer's high-hand (i.e., the five-card hand) is ranked queen high.

Other attempts have been made to increase the attractiveness of pai gow poker to potential players despite collecting a commission. For example, Sycuan Casino offers a game called “Double Hand Baccarat,” which is described as being “similar to Pai Gow” on its website as of Feb. 3, 2014, on the World Wide Web at sycuan.com/casino/asian_games/double-hand-baccarat/. Briefly, four cards are dealt to each player and the dealer, and those cards are arranged into two, two-card hands. Hands are ranked with pairs being high (from a pair of aces (high) to a pair of twos (low)), and modulo ten scoring (e.g., baccarat scoring) is used for nonpair hands. Nonpair hands rank below pair hands. The rules state that “a win and a copy is a ‘win’ for either the players or the dealer. The dealer's advantage is that ‘copy-copy’ is a ‘win’ for the dealer.” Although not specifically described on the website, a commission on wagers won and lost is retained by the house.

### BRIEF SUMMARY

In some embodiments, methods of administering wagering games may involve accepting an ante wager from a player to play a wagering game against a dealer. Randomized cards from a deck including 52 standard playing cards may be dealt to the player and to the dealer. The player's arrangement of the cards dealt to the player into a high player hand and a low player hand may be accepted or the cards dealt to the player may be arranged by the game administrator into a high player hand and a low player hand. The cards dealt to the dealer may also be arranged into a high dealer hand and a low dealer hand. The ante wager may be resolved by comparing the high player hand to the high dealer hand and the low player hand to the low dealer hand.

In some examples, the high card hand and the low card hands are two-card hands. The ranking system incorporates pairs, which outrank point totals that are arrived at using baccarat scoring, modulo 10. The strength of the pairs is based on rank, with aces being the highest ranking pair and twos being the lowest ranking pair. The next-highest ranking hand has a point total of nine, and the lowest point total is zero.

The amount of the ante wager may be collected when one tie exists in either the player and dealer high hands, or the player and dealer low hands. A tie is defined as a hand of equal rank. For example, if the player and dealer both hold a pair of fives in the low hand, there is a single tie. In another example, if the player holds a seven-two in the high hand and the dealer holds a six-three in the high hand, a tie exists because the point total of the two high hands is equal. In other words, the amount of the ante wager may be collected when one of the high player hand and the low player hand is of the same rank as a corresponding one of the high dealer hand and the low dealer hand, respectively, and the other of the high player hand and the low player hand is of a different rank than a corresponding other of the high dealer hand and the low dealer hand, respectively. A payout on the ante wager may be paid to the player when the high player hand is of a same rank as the high dealer hand and the low player hand is composed of cards of the same rank as cards of the low dealer hand.

In some embodiments, the ante wager may result in a push if one of the player's hands outranks one of the dealer's hands. When both dealer hands outrank both player hands, the ante may be collected by the house. A payout may be paid on the ante wafer if both player hands outrank both dealer hands.

In other embodiments, methods of administering wagering games may involve accepting an ante wager from a player to play a wagering game against a dealer. Randomized cards from a deck including 52 standard playing cards may be dealt to the player and to the dealer. The deck may include one or two wild cards such as jokers in some examples. The player's arrangement of the cards dealt to the player into a high player hand and a low player hand may be accepted or the cards dealt to the player may be arranged by the game administrator into a high player hand and a low player hand. The cards dealt to the dealer may be arranged into a high dealer hand and a low dealer hand. The ante wager may be resolved by comparing the high player hand to the high dealer hand and the low player hand to the low dealer hand.

A payout may be paid on the ante wager to the player when the high player hand outranks the high dealer hand and the low player hand outranks the low dealer hand. An amount of the ante wager may be returned to the player when one of the high player hand and the low player hand outranks a corresponding one of the high dealer hand and the low dealer hand, respectively, and the other of the high player hand and the low player hand is outranked by a corresponding other of the high dealer hand and the low dealer hand, respectively. The amount of the ante wager may be collected when the high player hand is outranked by the high dealer hand and the low player hand is outranked by the low dealer hand. A payout on the ante wager may be paid to the player when the high player hand is of a same rank as the high dealer hand and the low player hand is of the same rank as the low dealer hand. The amount of the ante wager may be collected when one of the high player hand and the low player hand is of the same rank as a corresponding one of the high dealer hand and the low dealer hand, respectively, and the other of the high player hand and the low player hand is of a different rank than a corresponding other of the high dealer hand and the low dealer hand, respectively.

In still other embodiments, methods of administering wagering games over networks utilizing processors may involve receiving at a server comprising a processor authorization from a player to allocate funds to an ante wager to play a wagering game against dealer hands. The server may randomly assign rank and suit information correlating to cards from a deck including 52 standard playing cards to the player and to the dealer hands. The server may accept the player's arrangement of the cards assigned to the player into a high player hand and a low player hand or the server may arrange the cards dealt to the player into a high player hand and a low player hand. The server may arrange the cards assigned to the dealer hands into a high dealer hand and a low dealer hand. The ante wager may be resolved by comparing at the server the high player hand to the high dealer hand and the low player hand to the low dealer hand.

The server may authorize collection of the amount of the ante wager when there is a single tie, that is one of the high player hand and the low player hand is of the same rank as a corresponding one of the high dealer hand and the low dealer hand, respectively, and the other of the high player hand and the low player hand is of a different rank than a corresponding other of the high dealer hand and the low dealer hand, respectively The server may authorize payment of a payout to the player when there is a double tie, that is the high player hand is of a same rank as the high dealer hand and the low player hand is of the same rank as the low dealer hand.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a flowchart diagram of a method of administering a wagering game, according to an embodiment of this disclosure;

FIG. 2 is a diagram of a playing surface for implementation of a method of administering a wagering game, according to an embodiment of this disclosure;

FIG. 3 is an enlarged diagram of a player position of the playing surface of FIG. 2;

FIG. 4 is a perspective view of a gaming table configured for implementation of embodiments of wagering games in accordance with this disclosure;

FIG. 5 is a perspective view of an individual electronic gaming device configured for implementation of embodiments of wagering games in accordance with this disclosure;

FIG. 6 is a top view of a table configured for implementation of embodiments of wagering games in accordance with this disclosure;

FIG. 7 is a perspective view of another embodiment of a table configured for implementation of embodiments of wagering games in accordance with this disclosure, wherein the implementation includes a virtual dealer;

FIG. 8 is a schematic block diagram of a gaming system for implementing embodiments of waging games in accordance with this disclosure;

FIG. 9 is a schematic block diagram of a gaming system for implementing embodiments of wagering games including a live dealer feed;

FIG. 10 is a block diagram of a computer for acting as a gaming system for implementing embodiments of wagering games in accordance with this disclosure;

FIG. 11 is a flowchart diagram of a method of administering a wagering game, which may be at least partially player-pooled, according to a player-pooled progressive embodiment; and

FIG. 12 is a flowchart diagram of a method of administering a wagering game, which may also be at least partially player-pooled, according to a dividend refund embodiment.

### DETAILED DESCRIPTION

The illustrations presented in this disclosure are not meant to be actual views of any particular act in a method of administering a wagering game, apparatus for use in administering a wagering game, or component thereof, but are merely idealized representations employed to describe illustrative embodiments. Thus, the drawings are not necessarily to scale. Additionally, elements common between figures may retain the same or similar numerical designation. Elements with the same number, but including a different alphabet character as a suffix should be considered as multiple instantiations of substantially similar elements and may be referred generically without an alphabet character suffix.

The terms “gaming,” “gambling,” or the like, refer to activities, games, sessions, rounds, hands, rolls, operations, and other events related to wagering games such as web-based games, casino games, card games, dice games, and other games the outcome of which is at least partially based on one or more random events (“chance” or “chances”), and on which wagers may be placed by a player. In addition, the words “wager,” “bet,” “bid,” or the like, refer to any type of wager, bet, or gaming venture that is placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that involve the risk of real-world monetary value for the potential of payouts with real-world monetary value (e.g., the “play-for-pay,” such as “house-banked,” “player-banked,” “player-pooled” including “player-pooled progressive,” and “dividend refund” configurations, each of which is described in more detail below) or in wagering games that involve no real-world monetary risks for the player (e.g., the “play-for-fun” and “social play-for-fun” configurations described in more detail below).

As used herein, the term “wager” includes any form of wagering value, including money, casino chips, other physical means for payment, and online or remote electronic authorization of a wager in any acceptable form to the casino or online or virtual game host. Also included are physical representations of money (e.g., casino chips) at a local gaming, as well as virtual representations of money in the form of electronic authorizations of a transfer of money and digital representations of money (e.g., digital representations of bills or coins, digital representations of chips, numerical quantities of money, numerical quantities of points, or numerical quantities of credits) at a local or remote electronic gaming device. As used herein, the term “wagering element” means and includes objects and symbols used to signify the acceptance of a wager. For example, physical wagering elements include physical money (e.g., bills and coins) and physical wagering tokens (e.g., poker chips), which may or may not be redeemable for monetary value and may or may not include electronic identifiers (e.g., RFID chips) embedded within the tokens, enabling electronic sensing and tracking of wagering. Virtual wagering elements include, for example, images (e.g., images of money or poker chips) and text (e.g., a string of numbers), which may or may not be redeemable for monetary value. In the “play-for-fun” and “social play-for-fun” configurations, a “wager” may not have a cash value (i.e., a real-world monetary value).

For the purposes of this description, it will be understood that when an action related to accepting wagers, making payouts, dealing cards, selecting cards, or other actions associated with a player or a dealer is described herein, and such description includes a player or a dealer taking the action, the results of the action may be computer generated and may be displayed on a live or virtual table or electronic display, and, if applicable, the reception or detection of such an action in an electronic form where player and dealer choices, selections, or other actions are received at an electronic interface. This further includes the results of a virtual dealer and virtual players, where the actions described are actually generated by a computer (typically associated with an online game). By way of a further example, if dealing of a card is described herein, the description includes (but is not limited to) the following: the dealing of a card by a dealer from a deck, shuffler, shoe, or other card source and the reception or placement of the card at a table location associated with a player or reception directly by a player; the generation and transmission of an electronic indication or representation of a card from a game play source or server to an electronic receiver, where the receiver may be at a table (using virtual cards) including players and/or virtual players and/or a dealer or virtual dealer, on a gaming terminal, at a public display in a casino, at a remote location (e.g., using online or Internet game play), or at other locations. Also included is the representation of a card on a display or displays, and, if applicable to the action described, an electronic reception of an indication that the card has been received, selected, or otherwise interacted with at a location associated with a player, or, associated with a virtual player. In addition, dealing of a card may refer to revealing a representation of a card on a scratch-off card (also referred to as “scratchers”).

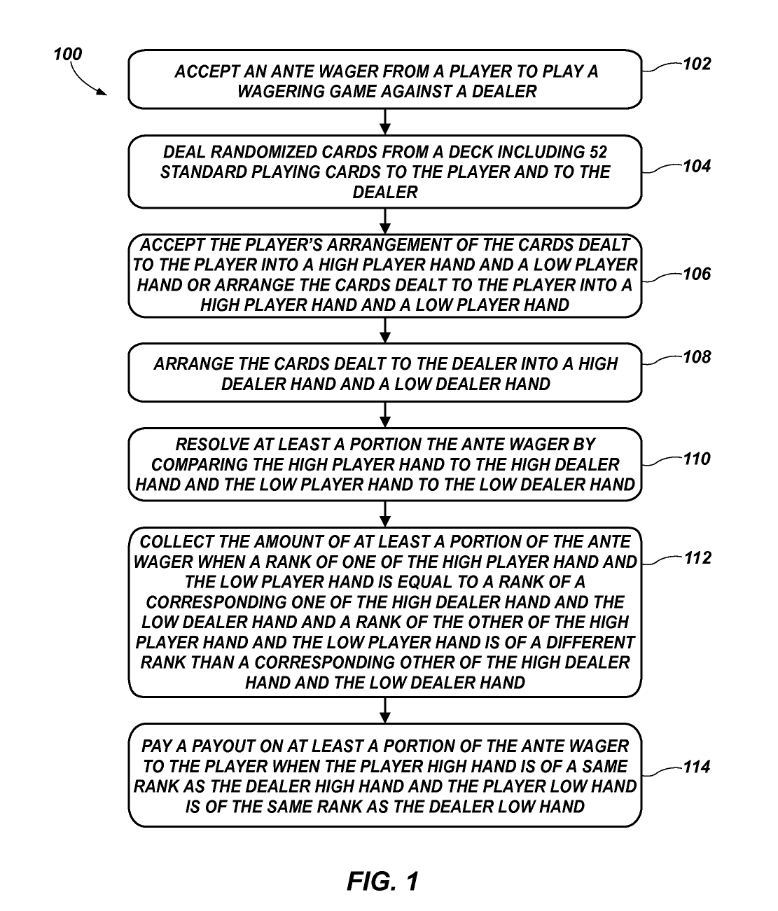

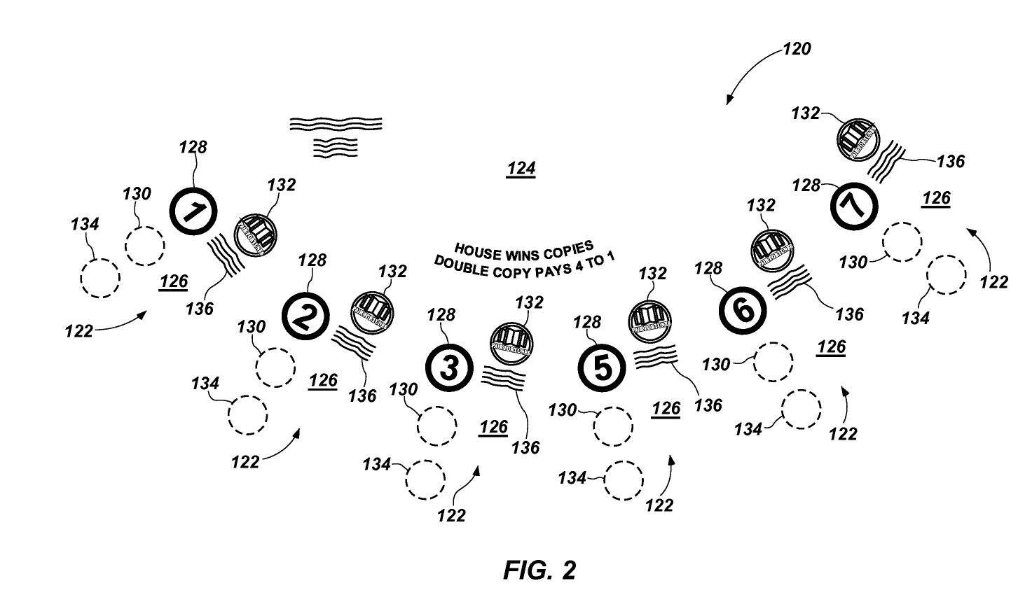

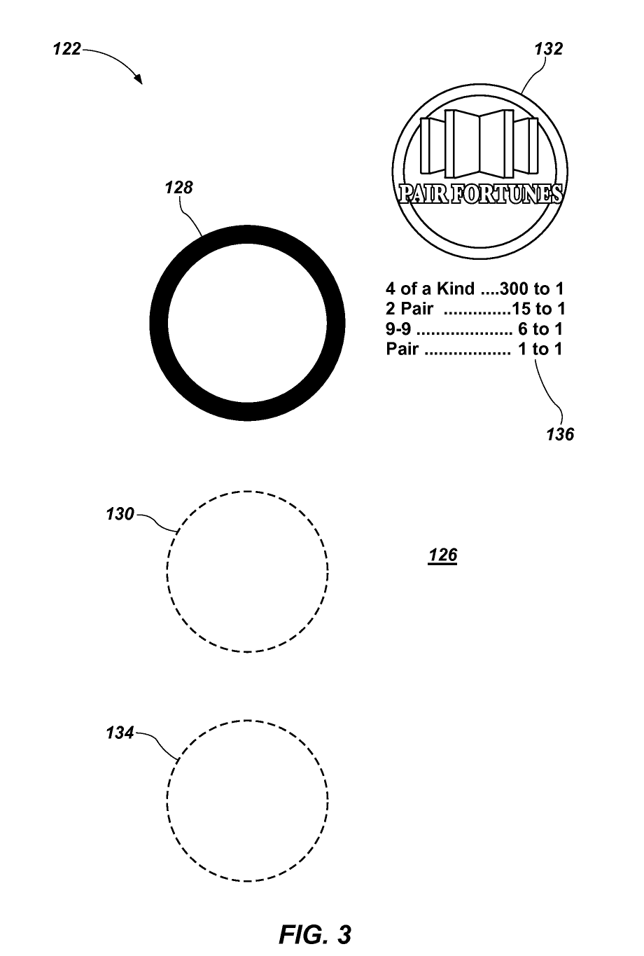

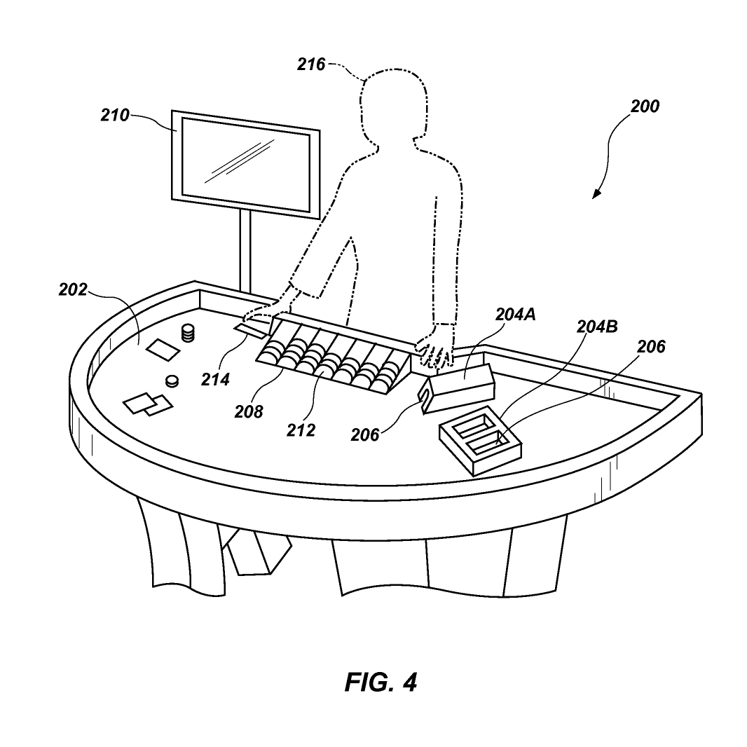

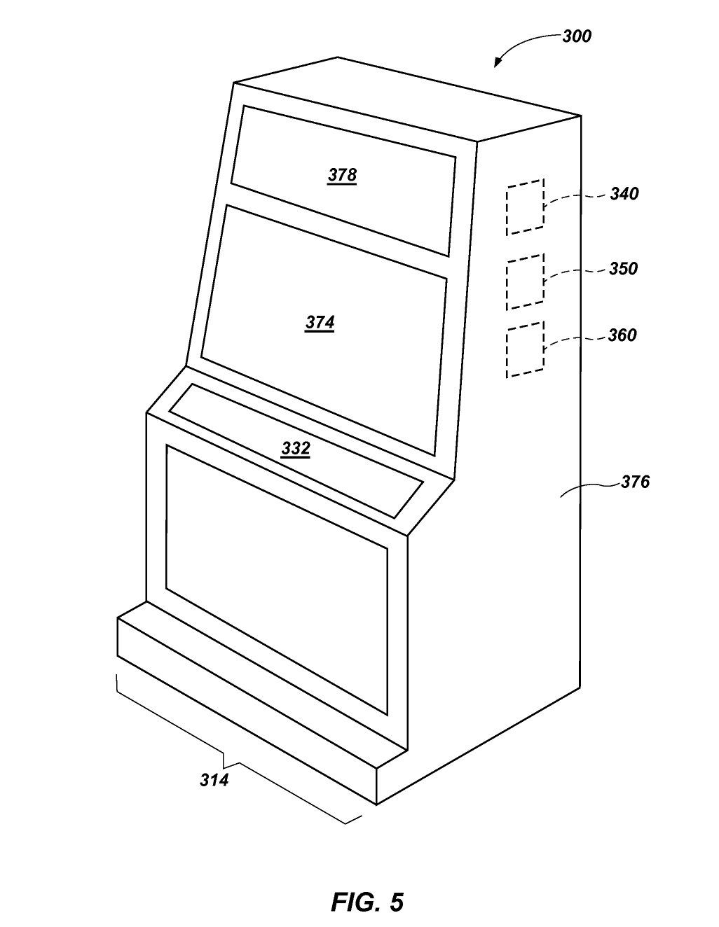

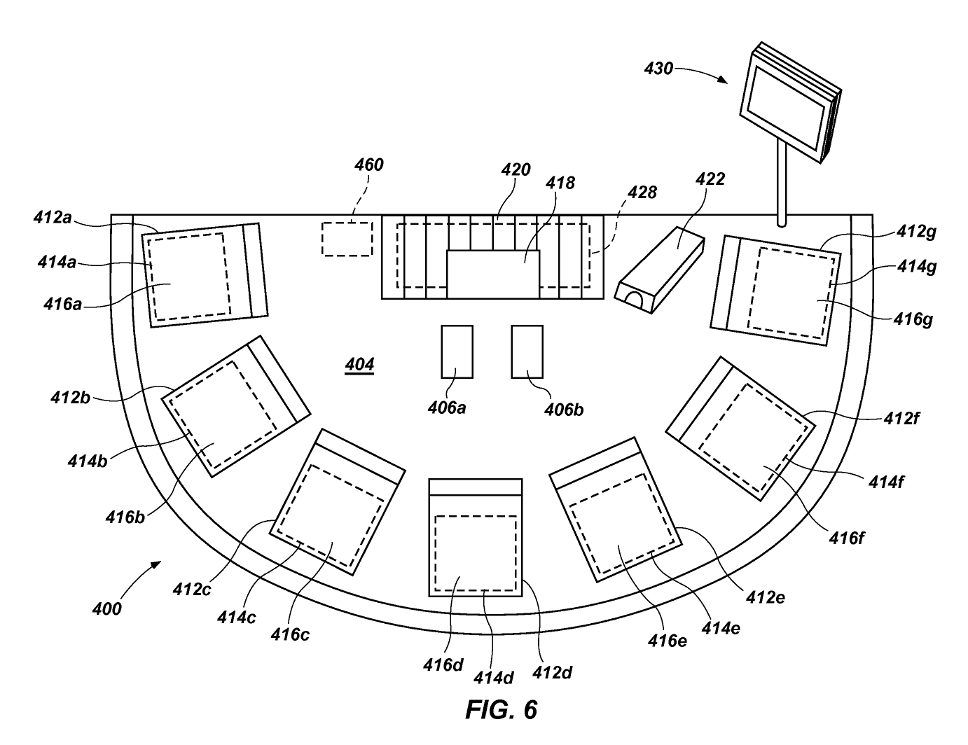

Referring to FIG. 1, a flowchart diagram of a method 100 of administering a wagering game is shown. The method 100 may involve accepting an ante wager from a player to play a wagering game against a dealer, as shown at 102. The ante wager may be, for example, a mandatory wager to participate in a variant of pai gow poker against a dealer. More specifically, an outcome of the ante wager may depend on the comparative ranks of a player's high and low hands and a dealer's high and low hands, which may be arranged during the course of the wagering game. The ante wager may be accepted, for example, by physically receiving a monetarily valuable wagering element on a designated betting area, by a processor receiving a signal from a user interface indicating a wager has been received, or by receiving electronic authorization to charge a player account (e.g., a credit account or a bank account). More specifically, the ante wager may be accepted, for example, by physically receiving wagering elements within a designated area 128 (see FIGS. 2, 3) on a surface 120 (see FIG. 2) of a gaming table 200, 400, or 500 (see FIGS. 4, 6, 7), by automatically detecting (e.g., using sensors, such as, for example, optical or RFID sensors) the presence of wagering elements within a designated area 128 (see FIGS. 2, 3) on a playing surface 120 of a playing table 200, 400, or 500 (see FIGS. 4, 6, 7), or by receiving electronic authorization at a processor 350, 414, 428, 597, or 642 (see FIGS. 5-7, 10) to charge a player account via a player interface 332, 416, 532, 624, or 644 (see FIGS. 5-8, 10) or dealer interface 418 (see FIG. 6), where the player interface may be remotely located from the dealer or a server of which the processor 350, 414, 428, 597, or 642 (see FIGS. 5-7, 10) is a component. As a specific, nonlimiting example, the ante wager may be accepted by receiving a physical, monetarily valuable wagering element 212 (see FIG. 4) in a first designated area 128 (see FIGS. 2, 3) on a surface 120 (see FIG. 2) of a gaming table 200, 400, or 500 (see FIGS. 4, 6, 7).

In some embodiments, the ante wager may be a two-part wager. For example, the ante wager may include a first part wagered on a first hand of a variant of pai gow poker and a second part wagered on a second hand of the variant of pai gow poker. As another example, the ante wager may include a first part wagered on both hands of a variant of pai gow poker and a second part wagered on one of the hands of the variant of pai gow poker. More specifically, the ante wager may include a first part wagered on both hands of the variant of pai gow poker and a second part assigned to one of the player hands after the player hands are arranged. In some embodiments, each part of the two-part ante wager may be of a different monetary value. For example, a player's election to assign the higher-value part of the two-part wager to one of the high player hand and the low player hand may be accepted, and the lower-value part of the two-part wager may be automatically assigned to the other of the high player hand and the low player hand. As another example, a higher-value part of the two-part wager may be automatically wagered on both hands of a variant of pai gow poker and a player's election to assign a lower-value part of the two-part wager to one of the high player hand and the low player hand may be accepted after the high player hand and the low player hand have been arranged. The specific values for the parts of the two-part wager may be, for example, fixed by the house or a player's selection of specific values from within a range of values fixed by the house may be accepted. In other embodiments, each part of the two-part ante wager may be of the same monetary value.

The two-part ante wager may be accepted by performing any of the actions described previously in connection with accepting the ante wager, with the exception that at least two wagering elements may be received or detected. As a specific, nonlimiting example, the two-part ante wager may be accepted by receiving a first physical, monetarily valuable wagering element 212 (see FIG. 4) in a first designated area 128 (see FIGS. 2, 3) on a surface 120 (see FIG. 2) of a gaming table 200, 400, or 500 (see FIGS. 4, 6, 7) and receiving a second physical, monetarily valuable wagering element 212 (see FIG. 4) in a second designated area 130 (see FIGS. 2, 3) on the surface 120 (see FIG. 2) of the gaming table 200, 400, or 500 (see FIGS. 4, 6, 7).

In some embodiments, a side wager may be accepted from the player. The side wager may be, for example, mandatory in some embodiments and optional in other embodiments. An outcome of the side wager may depend on the arrangement of the player's hands and may not depend on a comparison to the dealer's hands. For example, a ranking system may be employed to determine the strength of the hand and the corresponding payout on the side wager. The side wager may be accepted by performing any of the actions described previously in connection with accepting the ante wager. As a specific, nonlimiting example, the side wager may be accepted by receiving a physical, monetarily valuable wagering element 212 (see FIG. 4) in a third designated area 132 (see FIGS. 2, 3) on a surface 120 (see FIG. 2) of a gaming table 200, 400, or 500 (see FIGS. 4, 6, 7).

Randomized cards from a deck including at least 52 standard playing cards (i.e., ranks 2 through 10, jack, queen, king, and ace in each of four suits: spades, diamonds, clubs, and hearts) may be dealt to the player and to the dealer, as shown at 104. A total number of cards dealt to each of the player and the dealer may vary from, for example, two to seven. More specifically, the four, five, or six cards may be dealt to each of the player and the dealer. In some embodiments, one or more cards dealt to the dealer may be revealed to the player when dealt to the dealer. For example, one of the cards dealt to the dealer may be dealt face up, and the remaining cards dealt to the dealer may be dealt face down. In some embodiments, the deck may further include one or more wild or semi-wild cards. For example, the deck may include one, two, or more jokers, which may be designated as wild or semi-wild cards. In some embodiments, the deck may include more than one set of 52 standard playing cards. For example, the deck may include six or eight sets of 52 standard playing cards. In other embodiments, the deck may include a single set of 52 standard playing cards. The cards may be randomized, for example, by hand-shuffling a physical deck, by machine-shuffling a physical deck using a card-shuffling device 204B (see FIG. 4), or by randomly selecting computer-simulated cards from a computer-simulated deck using a processor 350, 414, 428, 597, or 642 (see FIGS. 5-7, 10). The cards may be dealt, for example, by hand-dealing physical cards from a physical deck, by hand-dealing cards removed from a card-shuffling device 204B (see FIG. 4), or by displaying computer-simulated cards on an electronic display device 210, 332, 374, 404, 416, 430, 532, 560, 564, 622, 658, and 688 (see FIGS. 4-7, 9, 10).

In some embodiments, a player's election to discard one or more cards may be accepted and randomized replacement cards may be dealt to the player from the deck. For example, a single card may be accepted from the player, and one randomized replacement card may be dealt to the player from the deck. The player's election to discard one or more cards may be accepted by, for example, receiving one or more physical cards from the player, which physical cards may then be placed, for example, in a discard pile or reinserted into a card-shuffling device 204B (see FIG. 4), or by receiving an electronic selection at a processor 350, 414, 428, 597, or 642 (see FIGS. 5-7, 10) to discard one or more of the cards dealt to the player via a player interface 332, 416, 532, 624, or 644 (see FIGS. 5-8, 10) or dealer interface 418 (see FIG. 6). The replacement card or cards may be dealt by performing any of the actions described previously in connection with dealing cards.

In some embodiments, the dealer may discard one or more cards and randomized replacement cards may be dealt to the dealer from the deck. For example, the dealer may discard a single card, and one randomized replacement card may be dealt to the dealer from the deck. The dealer may discard one or more cards by, for example, removing one or more physical cards from the cards initially dealt to the dealer, which physical cards may then be placed, for example, in a discard pile or reinserted into a card-shuffling device 204B (see FIG. 4), by receiving an electronic selection at a processor 350, 414, 428, 597, or 642 (see FIGS. 5-7, 10) to discard one or more of the cards dealt to the dealer via a dealer interface 418 (see FIG. 6), or by automatically selecting at a processor 350, 414, 428, 597, or 642 (see FIGS. 5-7, 10) one or more of the cards dealt to the dealer. The replacement card or cards may be dealt by performing any of the actions described previously in connection with dealing cards. In some embodiments, a total number of cards dealt to the dealer may be greater than the total number of cards dealt to the player. In such embodiments, the dealer may discard one or more cards after arranging the cards dealt to the dealer into a high dealer hand and a low dealer hand such that the number of cards in the high dealer hand is equal to the number of cards in the high player hand and the number of cards in the low dealer hand is equal to the number of cards in the low player hand.

The player's arrangement of the cards dealt to the player into a high player hand and a low player hand may be accepted, as indicated at 106. A total number of cards assigned to the high player hand may range from, for example, one to six. A total number of cards assigned to the low player hand may be between, for example, one and three. In some embodiments, the total number of cards assigned to the high player hand may be equal to the total number of cards assigned to the low player hand. In other embodiments, the total number of cards assigned to the high player hand may be different from (e.g., greater than or less than) the total number of cards assigned to the low player hand. In some embodiments, each card dealt to the player must be included in either the high player hand or the low player hand. In other embodiments, a player's election to discard one or more cards, rather than assign them to one of the high player hand and the low player hand, may be accepted. For example, the total number of cards dealt to the player may be greater than the number of cards in the high player hand plus the number of cards in the low player hand. In some embodiments, each of the high player hand and the low player hand may contain no more than three cards, which may enable the high player hand and the low player hand to be at least partially ranked using modulo ten rankings (i.e., adding the rank of all the cards in a given hand, with cards being assigned their number rank, face cards being assigned a rank of ten, and aces being assigned a rank of one, and assigning the hand the number in the ones place as its rank). In some embodiments, the high player hand must outrank the low player hand according to hand ranking rules for the wagering game. As a specific, nonlimiting example, the player's arrangement of four cards dealt to the player into a two-card high player hand and a two-card low player hand may be accepted.

Acceptance of the player's arrangement of cards into the high player hand and the low player hand may be reflected, for example, by leaving physical cards in a player position 122 on a surface 120 (see FIG. 2) of a gaming table 200, 400, or 500 (see FIGS. 4, 6, 7) undisturbed or by receiving an electronic election to arrange player cards in a selected arrangement at a processor 350, 414, 428, 597, or 642 (see FIGS. 5-7, 10) via a player interface 332, 416, 532, 624, or 644 (see FIGS. 5-8, 10) or dealer interface 418 (see FIG. 6) and displaying computer-simulated cards on an electronic display device 210, 332, 374, 404, 416, 430, 532, 560, 564, 622, 658, and 688 (see FIGS. 4-7, 9, 10) in the accepted arrangement.

Alternatively, the cards dealt to the player may be arranged into a high player hand and a low player hand by the dealer, as also shown at 106. For example, the dealer may arrange the cards dealt to the player into a high player hand and a low player hand according to a “house way,” which may be a fixed set of rules for arranging cards into high and low hands predetermined by the house. In some embodiments, the house way may require that a rank of the low hand be maximized while maintaining a rank of the high hand higher than the rank of the low hand. For example, in an embodiment where the high hand is composed of two cards and the low hand is composed of two cards, if the cards are capable of being arranged into two pairs, the house way may require that the higher pair be arranged into the high hand. If the cards are capable of being arranged only into one pair, the house way may require, for example, that the pair be arranged into the high hand. If none of the cards form a pair, the house way may require, for example, that the rank of the low hand be as high as possible without outranking the high hand.

The house way of arranging cards into a high hand and a low hand may be applied to the cards dealt to the player by, for example, the dealer physically arranging the cards dealt to the player into the high player hand and the low player hand, receiving at a processor 350, 414, 428, 597, or 642 (see FIGS. 5-7, 10) an electronic selection for arranging the cards dealt to the player into the high player hand and the low player hand via a dealer interface 418 (see FIG. 6), or automatically generating at a processor 350, 414, 428, 597, or 642 (see FIGS. 5-7, 10) an arrangement for the cards dealt to the player into the high player hand and the low player hand. In some embodiments, an indication for how to properly apply the house way to the cards dealt to the player may be displayed to the dealer (e.g., automatically or in response to a dealer input) on an electronic display device 210, 332, 374, 404, 416, 430, 532, 560, 564, 622, 658, and 688 (see FIGS. 4-7, 9, 10). For example, the indication for how to properly apply the house way to the cards dealt to the player may be generated and displayed in any of the ways and using any of the hardware described in U.S. Pat. No. 8,251,802, issued Aug. 28, 2012, to Snow or U.S. Pat. No. 8,262,475, issued Sep. 11, 2012, to Snow et al., the disclosure of each of which is incorporated into this disclosure in its entirety by this reference.

Arranging the cards dealt to the player into the high player hand and the low player hand may be reflected, for example, by positioning physical cards within a player position 122 on a surface 120 (see FIG. 2) of a gaming table 200, 400, or 500 (see FIGS. 4, 6, 7) in the arrangement dictated by the house way or by displaying computer-simulated cards on an electronic display device 210, 332, 374, 404, 416, 430, 532, 560, 564, 622, 658, and 688 (see FIGS. 4-7, 9, 10) in the required arrangement.

In some embodiments, a play wager or an election to fold may be accepted from the player after the cards have been dealt to the player. When a play wager is accepted, the ante wager and any side wagers previously accepted from the player may remain in play. For example, the amounts accepted for the ante wager (e.g., the total amount of a one-part ante wager both parts of a two-part wager) and any side wager from the player may remain at risk when the play wager is accepted from the player. As a specific, nonlimiting example, physical, monetarily valuable wagering elements associated with the ante wager and any side wager may be left in the first designated area 128 (see FIGS. 2, 3), the second designated area 130 (see FIGS. 2, 3) in embodiments where the ante wager is a two-part wager, and the third designated area 132 (see FIGS. 2, 3) in embodiments where a side wager was accepted from the player on the surface 120 (see FIG. 2) of the gaming table 200, 400, or 500 (see FIGS. 4, 6, 7), respectively. The play wager may be accepted by performing any of the acts described previously in connection with accepting the ante wager. As a specific, nonlimiting example, the play wager may be accepted by receiving a physical, monetarily valuable wagering element on the surface 120 (see FIG. 2) of a gaming table 200, 400, or 500 (see FIGS. 4, 6, 7), such as, for example, in or adjacent to the first designated area 128 (see FIGS. 2, 3) or in a fourth designated area 134 (see FIGS. 2, 3) specifically for receiving the play wager.

When the play wager is accepted, an amount of the play wager may be added to the amount of the ante wager in some embodiments. For example, the amount of the play wager may be added to the amount of a one-part wager, and the outcome of both the ante wager and the play wager may depend on the ranks of the high player hand and the low player hand as compared to the ranks of a high dealer hand and a low dealer hand, respectively. In other embodiments, the amount of the play wager may be allocated to an outcome of a single hand. For example, the outcome of the play wager may depend on the rank of the high player hand or the low player hand as compared to the high dealer hand or the low dealer hand, respectively. As another example, the amount of the play wager may be added to an amount of one part of a two-part ante wager.

When a player's election to fold is accepted, at least one wagering element associated with the ante wager may be collected for the house. For example, all wagering elements associated with the ante wager may be collected for the house. As another example, one part of a two-part ante wager may be collected for the house and the other part of the two-part ante wager may remain in play. In some embodiments, the wagering elements associated with any side wager accepted from the player may remain in play despite accepting a player's election to fold. In other embodiments, the wagering elements associated with the side wager may be collected for the house when a player's election to fold is accepted.

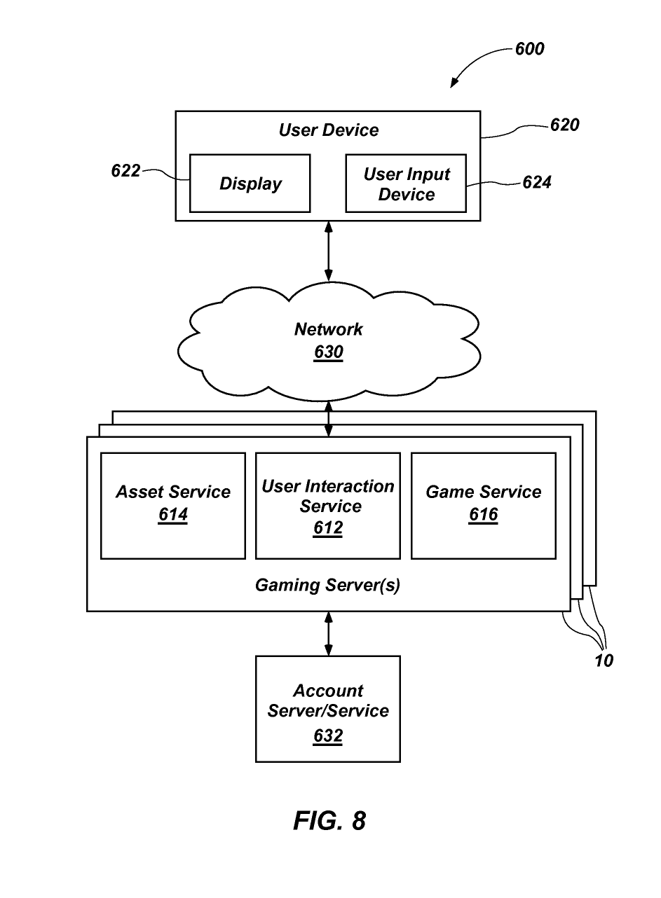

A player's election to fold may be accepted, for example, by visually, aurally, or electronically receiving a player's indication that the player elects to fold and physically retrieving at least one wagering element associated with the ante wager from the surface 120 (see FIG. 2) of a gaming table 200, 400, or 500 (see FIGS. 4, 6, 7), visually, aurally, or electronically receiving a player's indication that the player elects to fold and receiving at a processor 350, 414, 428, 597, or 642 (see FIGS. 5-7, 10) an electronic indication that the player's election to fold has been accepted via a dealer interface 418 (see FIG. 6), or receiving at a processor 350, 414, 428, 597, or 642 (see FIGS. 5-7, 10) an electronic indication that the player elects to fold via a player interface 332, 416, 532, 624, or 644 (see FIGS. 5-8, 10) or dealer interface 418 (see FIG. 6) and electronically authorizing collection of at least a portion of the ante wager for the house. Wagering elements may be collected for the house by, for example, physically retrieving the wagering elements associated with the ante wager from the surface 120 (see FIG. 2) of the gaming table 200, 400, or 500 (see FIGS. 4, 6, 7) and transferring them to a rack 208 or 420 (see FIGS. 4, 6) of house wagering elements or generating electronic authorization (e.g., automatically or in response to a player or dealer input) at a processor 350, 414, 428, 597, or 642 (see FIGS. 5-7, 10) to transfer an amount of the ante wager to a house account 632 (see FIG. 8). The play wager may be optional in some embodiments. In other embodiments, the play wager may be mandatory, in which case any attempt by a player to fold may not be accepted.

In some embodiments where the ante wager is a two-part wager, a player's election to allocate one or both parts of the two-part ante wager to a selected outcome may be accepted after the high player hand and the low player hand have been arranged (or simply after the cards have been dealt to the player). For example, an outcome of one part of the two-part ante wager may depend permanently on the ranks of the high player hand and the low player hand as compared to the ranks of the high dealer hand and the low dealer hand, respectively, and a player's election to wager the other part of the two-part ante wager on the rank of the high player hand or the low player hand as compared to the high dealer hand or the low dealer hand, respectively, may be accepted after the high player hand and the low player hand have been arranged (or simply after the cards have been dealt to the player). As another example, a player's election to wager one part of the two-part ante wager on the rank of one of the high player hand and the low player hand as compared to a corresponding one of the high dealer hand and the low dealer hand, respectively, may be accepted, and a player's election to wager the other part of the two-part ante wager on the rank of the other of the high player hand and the low player hand as compared to the corresponding other of the high dealer hand and the low dealer hand, respectively, may be accepted after the high player hand and the low player hand have been arranged (or simply after the cards have been dealt to the player).

The cards dealt to the dealer may be arranged into a high dealer hand and a low dealer hand, as shown at 108. For example, the dealer may arrange the cards dealt to the dealer into a high dealer hand and a low dealer hand according to the house way. In some embodiments, the house way may require that a rank of the low hand be maximized while maintaining a rank of the high hand higher than the rank of the low hand. For example, in an embodiment where the high hand is composed of two cards and the low hand is composed of two cards, if the cards are capable of being arranged into two pairs, the house way may require that the higher pair be arranged into the high hand. If the cards are capable of being arranged only into one pair, the house way may require, for example, that the pair be arranged into the high hand. If none of the cards form a pair, the house way may require, for example, that the rank of the low hand be as high as possible without outranking the high hand. The house way of arranging cards dealt to the dealer into a high dealer hand and a low dealer hand may be carried out by performing any of the acts described previously in connection with arranging cards dealt to the player into the high player hand and the low player hand according to the house way. In embodiments where the cards dealt to the dealer are required to be arranged according to the house way, the cards dealt to the player may be dealt face up because the house way may eliminate strategic hand arrangements that a dealer may otherwise make in response to viewing the high player hand and the low player hand.

A total number of cards assigned to the high dealer hand may range from, for example, one to six. A total number of cards assigned to the low dealer hand may be between, for example, one and three. In some embodiments, the total number of cards assigned to the high dealer hand may be equal to the total number of cards assigned to the low dealer hand. In other embodiments, the total number of cards assigned to the high dealer hand may be different from (e.g., greater than or less than) the total number of cards assigned to the low dealer hand. In some embodiments, each card dealt to the dealer must be included in either the high dealer hand or the low dealer hand. In other embodiments, the dealer may discard one or more cards, rather than assign them to one of the high dealer hand and the low dealer hand. For example, the total number of cards dealt to the dealer may be greater than the number of cards in the high dealer hand plus the number of cards in the low dealer hand. In some embodiments, each of the high dealer hand and the low dealer hand may contain no more than three cards, which may enable the high dealer hand and the low dealer hand to be at least partially ranked using modulo ten rankings (e.g., baccarat rankings). In some embodiments, the high dealer hand must outrank the low dealer hand according to hand ranking rules for the wagering game. As a specific, nonlimiting example, the four cards dealt to the dealer may be arranged into a two-card high dealer hand and a two-card low dealer hand, with pairs outranking nonpairs. Within pair rankings, individual card rankings may determine relative ranking of pairs. Pairs of aces may be a highest-ranking pair, followed by kings, queens, etc., with a pair of twos being a lowest-ranking pair. Pairs are followed by nonpair hand rankings, which are scored based on baccarat rankings, modulo 10, with a point total of nine being a highest nonpair hand and a point value of zero being the lowest nonpair hand. A pair of twos may beat a nonpair point total of nine, and a nine-point total may beat an eight-point total, for example.

Arranging the cards dealt to the player into the high player hand and the low player hand may be reflected, for example, by positioning physical cards within a player position 122 on a surface 120 (see FIG. 2) of a gaming table 200, 400, or 500 (see FIGS. 4, 6, 7) in the arrangement dictated by the house way or by displaying computer-simulated cards on an electronic display device 210, 332, 374, 404, 416, 430, 532, 560, 564, 622, 658, and 688 (see FIGS. 4-7, 9, 10) in the required arrangement.

In some embodiments, at least a portion of the ante wager may be resolved by comparing the high player hand to the high dealer hand and the low player hand to the low dealer hand, as indicated at 110. For example, an entire amount of the ante wager may be resolved by comparing a rank of the high player hand to a rank of the high dealer hand and a rank of the low player hand to a rank of the low dealer hand. As another example, one part of a two-part ante wager may be resolved by comparing the rank of the high player hand to the rank of the high dealer hand and the rank of the low player hand to the rank of the low dealer hand. In some embodiments, hands that achieve a poker rank of a pair or greater may be ranked according to poker rankings for hands composed of a given number of cards and hands that do not achieve a poker rank of at least a pair (i.e., achieve a poker rank of high card) may be ranked according to modulo ten rankings. For example, in embodiments where each hand is composed of two cards, the hands may be ranked by pairs (e.g., in descending order, pairs of aces, kings, queens, jacks, and tens down to twos) and then by modulo ten rankings for hands that are not pairs.

In some embodiments, at least a portion of the ante wager may be resolved by comparing the high player hand to the high dealer hand or comparing the low player hand to the low dealer hand. For example, one part of a two-part ante wager may be resolved by comparing the rank of the high player hand to the rank of the high dealer hand or comparing the rank of the low player hand to the rank of the low dealer hand. As another example, each part of a two part wager may be resolved separately by comparing the rank of the high player hand to the rank of the high dealer hand and comparing the rank of the low player hand to the rank of the low dealer hand.

The high player hand may be compared to the high dealer hand and the low player hand may be compared to the low dealer hand by, for example, revealing all as-yet unrevealed cards in the dealer and player hands and visually inspecting the hands to determine which is of higher rank, revealing all as-yet unrevealed cards in the dealer and player hands and electronically inspecting and evaluating the hands (e.g., using sensors, such as, for example, optical or RFID sensors and a processor 350, 414, 428, 597, or 642 (see FIGS. 5-7, 10)) to determine which is of higher rank, or electronically evaluating computer-simulated hands at a processor 350, 414, 428, 597, or 642 (see FIGS. 5-7, 10) to determine which is of higher rank. As a specific, nonlimiting example, the dealer may physically turn cards of the high dealer hand and the low dealer hand face up, and the hands may be visually inspected by the dealer to determine which hand is of higher rank.

In some embodiments, the high dealer hand, the low dealer hand, or the high dealer hand and the low dealer hand may be evaluated to determine whether they qualify for participation in the wagering game. For example, when the high dealer hand, the low dealer hand, or the high dealer hand and the low dealer hand are ranked lower than a predetermined, qualifying rank, at least a portion of the ante wager may be returned to the player. More specifically, when the high dealer hand, the low dealer hand, or the high dealer hand and the low dealer hand are ranked lower than a predetermined, qualifying rank, an entire amount of the ante wager may be returned to the player (i.e., the ante wager may “push”). The predetermined, qualifying rank may be, for example, queen high in the high dealer hand, modulo ten score of 4 in the low dealer hand, or a pair in the high dealer hand. As another example, when the high dealer hand, the low dealer hand, or the high dealer hand and the low dealer hand are of a predetermined, disqualifying rank, at least a portion of the ante wager may be returned to the player. More specifically, when the high dealer hand, the low dealer hand, or the high dealer hand and the low dealer hand are of the predetermined, disqualifying rank, an entire amount of the ante wager may be returned to the player. The predetermined, disqualifying rank may be, for example, modulo ten score of four in the high dealer hand, modulo ten score of zero in the high dealer hand and the low dealer hand. As yet another example, when all the cards dealt to the dealer are of the same color, at least a portion of the ante wager may be returned to the player. More specifically, when all the cards dealt to the dealer are of the same color, an entire amount of the ante wager may be returned to the player.

In some embodiments, the high player hand, the low player hand, or the high player hand and the low player hand may be evaluated to determine whether they qualify for participation in the wagering game. For example, when the high player hand, the low player hand, or the high player hand and the low player hand are ranked lower than a predetermined, qualifying rank, at least a portion of the ante wager may be returned to the player. More specifically, when the high player hand, the low player hand, or the high player hand and the low player hand are ranked lower than a predetermined, qualifying rank, an entire amount of the ante wager may be returned to the player (i.e., the ante wager may “push”). The predetermined, qualifying rank may be, for example, queen high in the high player hand, modulo ten score of 4 in the low player hand, or a pair in the high player hand. As another example, when all the cards dealt to the player are of the same color, at least a portion of the ante wager may be returned to the player. More specifically, when all the cards dealt to the player are of the same color, an entire amount of the ante wager may be returned to the player.

In some embodiments, the dealer hands and the player hands may be evaluated to determine whether they qualify for participation in the wagering game. For example, when all the cards dealt to the dealer and all the cards dealt to the player are of the same color, at least a portion of the ante wager may be returned to the player. More specifically, when all the cards dealt to the dealer and all the cards dealt to the player are of the same color, an entire amount of the ante wager may be returned to the player.

In embodiments where a wild card has been dealt to the player or the dealer, the wild card may increase the likelihood that the hand in which the wild card is arranged will outrank the hand to which it is compared. For example, a wild card may be used as a card of any rank or suit, such as, for example, to form a pair. As another example, a hand containing a wild card may automatically outrank any hand to which it is compared. As yet another example, any participant to whom a wild card is dealt may automatically win all wagers involving a comparison with that participant's hands.

In embodiments where a side wager was accepted from the player, the side wager may be resolved by comparing the high player hand and the low player hand to a set of predetermined winning hands. The high player hand and the low player hand may be compared to a set of predetermined winning hands by, for example, visually inspecting the high player hand, the low player hand, and a displayed set of predetermined winning hands to determine whether the rank of the high player hand, the rank of the low player hand, or the rank of the high player hand and the rank of the low player hand is the same as the rank of any of the predetermined winning hands; electronically inspecting (e.g., using sensors, such as, for example, optical or RFID sensors) the high player hand and the low player hand, and electronically accessing (e.g., in memory 340, 595, or 646 (see FIGS. 5, 7, 10)) a stored set of predetermined winning hands to determine whether a rank of the high player hand, is the same as the rank of any of the predetermined winning hands; or computer-simulated hands may be electronically inspected at a processor 350, 414, 428, 597, or 642 (see FIGS. 5-7, 10) to determine whether the rank of the high player hand, the rank of the low player hand, or the rank of the high player hand and the rank of the low player hand is the same as the rank of any of the predetermined winning hands. As a specific, nonlimiting example, the high player hand and the low player hand may be visually compared by the dealer to a pay table listing hands qualifying as predetermined winning hands to determine whether the rank of the high player hand, the rank of the low player hand, or the rank of the high player hand and the rank of the low player hand are the same as the rank of any of the predetermined winning hands. Predetermined winning hands may be, for example, a pair of twos or higher.

A payout may be paid on at least a portion of the ante wager to the player when the high player hand outranks the high dealer hand and the low player hand outranks the low dealer hand. For example, the payout may be paid on the entire amount of the ante wager and the amount of any play wager added to the ante wager in embodiments where the ante wager is a one-part wager. As another example, the payout may be paid on one part of a two-part ante wager and the amount of any play wager added to the part of the two-part ante wager in some embodiments where the ante wager is a two-part wager. An amount of the payout may be proportional to the amount risked in connection with the relevant portion of the ante wager in some embodiments. For example, the amount of the payout may be equal to the amounts risked in connection with the relevant portion of the ante wager (i.e., a 1:1 payout). Paying the payout may involve, for example, physically transferring wagering elements, crediting a win meter, or granting electronic authorization to transfer funds to a player account. More specifically, the payout may be paid by, for example, physically giving wagering elements to a player on a playing surface 120 (see FIG. 2) of a gaming table 200, 400, or 500 (see FIGS. 4, 6, 7), receiving electronic authorization at a processor 350, 414, 428, 597, or 642 (see FIGS. 5-7, 10) via a dealer interface 418 (see FIG. 6) to transfer funds from a house account server 632 (see FIG. 8) to a player account, or automatically generating electronic authorization at the processor 350, 414, 428, 597, or 642 (see FIGS. 5-7, 10) to transfer funds from an account server 632 (see FIG. 8) to a player account. As a specific, nonlimiting example, the payout may be paid by physically transferring wagering elements from a rack 208 or 420 (see FIGS. 4, 6) to the player.

An amount of at least a portion of the ante wager may be returned to the player (i.e., the ante may push) when one of the high player hand and the low player hand outranks a corresponding one of the high dealer hand and the low dealer hand, respectively, and the other of the high player hand and the low player hand is outranked by a corresponding other of the high dealer hand and the low dealer hand, respectively. For example, when the high player hand outranks the high dealer hand, but the low player hand is outranked by the low dealer hand, at least a portion of the ante wager may be returned to the player. As another example, when the high player hand is outranked by the high dealer hand, but the low player hand outranks the low dealer hand, at least a portion of the ante wager may be returned to the player. In some embodiments, an entire amount of the ante wager may be returned to the player. For example, the entire amount of the ante wager, including the amount of any play wager added to the ante wager, may be returned to the player when the ante wage is a one-part wager. As another example, the entire amount of the ante wager, including the amount of any play wager added to the ante wager, may be returned to the player when the outcome of each part of a two-part ante wager depends on the comparative ranks of both the high player hand with respect to the high dealer hand and the low player hand with respect to the low dealer hand. In other embodiments, only a portion of the ante wager may be returned to the player. For example, one part of a two-part ante wager, including the amount of any play wager added to the relevant part of the ante wager, may be returned to the player.

Returning at least a portion of the ante wager to the player may involve, for example, physically transferring wagering elements associated with the relevant portion of the ante wager to the player, electronically authorizing transfer of the relevant portion of the ante wager to the player by sending an electronic signal to a processor 350, 414, 428, 597, or 642 (see FIGS. 5-7, 10) via a dealer interface 418 (see FIG. 6), or automatically generating at a processor 350, 414, 428, 597, or 642 (see FIGS. 5-7, 10) electronic authorization to transfer the relevant portion of the ante wager to an account of the player. As a specific, nonlimiting example, at least a portion of the ante wager may be returned to the player by physically transferring wagering elements from one or more designated areas 128 and 130 (see FIGS. 2, 3) on a playing surface 120 (see FIG. 2) of a gaming table 200, 400, or 500 (see FIGS. 4, 6, 7) to the player.

The amount of at least a portion of the ante wager may be collected for the house when the high player hand is outranked by the high dealer hand and the low player hand is outranked by the low dealer hand. In some embodiments, an entire amount of the ante wager, including the amount of any play wager added to the ante wager, may be collected for the house. In other embodiments, only a portion of the ante wager, which may or may not include the amount of any play wager added to the ante wager, may be collected for the house. For example, one part of a two-part ante wager, including the amount of any play wager added to the relevant part of the ante wager, may be collected for the house. Collecting at least a portion of the ante wager for the house may involve, for example, performing any of the acts described previously in connection with collecting the ante wager after accepting a player's election to fold.

A payout on at least a portion of the ante wager may be paid to the player when the high player hand is of a same rank as the high dealer hand and the low player hand is of the same rank as the low dealer hand, as indicated at 114. This condition may be referred to as a “double tie”. In some examples, the same rank may be a poker ranking or a baccarat score, modulo 10 ranking. In other words, a payout may be paid to the player when both of the player's hands tie with the dealer's hands. For example, the payout may be paid on the entire amount of the ante wager and the amount of any play wager added to the ante wager in embodiments where the ante wager is a one-part wager. As another example, the payout may be paid on one part of a two-part ante wager and the amount of any play wager added to the relevant part of the two-part ante wager in some embodiments where the ante wager is a two-part wager. An amount of the payout may be proportional to the amount risked in connection with the relevant portion of the ante wager in some embodiments. For example, the amount of the payout may be a multiple of the amounts risked in connection with the relevant portion of the ante wager (e.g., a 1:2 payout, 1:3 payout, 1:4 payout, etc.). Paying the payout may involve, for example, performing any of the acts described previously in connection with paying a payout on at least a portion of the ante wager.

In some embodiments, the amount of at least a portion of the ante wager may be collected for the house when one of the high player hand and the low player hand is of the same rank as a corresponding one of the high dealer hand and the low dealer hand and the other of the high player hand and the low player hand is of a different rank than a corresponding other of the high dealer hand and the low dealer hand, respectively, as indicated at 112. In other words, the house may win hand comparisons when one of the hands is a tie, but the other is not. For example, the amount of at least a portion of the ante wager may be collected for the house when the high player hand is of the same rank as the high dealer hand and the low player hand outranks or is outranked by the low dealer hand. As another example, the amount of at least a portion of the ante wager may be collected for the house when the high player hand outranks or is outranked by the high dealer hand and the low player hand is of the same rank as the low dealer hand. In some embodiments, an entire amount of the ante wager, including the amount of any play wager added to the ante wager, may be collected for the house. In other embodiments, only a portion of the ante wager, which may or may not include the amount of any play wager added to the ante wager, may be collected for the house. For example, one part of a two-part ante wager, including the amount of any play wager added to the relevant part of the ante wager, may be collected for the house. Collecting at least a portion of the ante wager for the house may involve, for example, performing any of the acts described previously in connection with collecting the ante wager after accepting a player's election to fold.

In some embodiments, at least a portion of the ante wager may be collected for the house when one of the high player hand and the low player hand is composed of cards of the same rank as cards of a corresponding one of the high dealer hand and the low dealer hand even though the hands are of the same rank, regardless of the outcome of a comparison of the other of the high player hand and the low player hand to the corresponding other of the high dealer hand and the low dealer hand. In other words, the house may win wagers when at least one of the hand comparisons is a copy, and the other compared hand is not a tie. For example, the amount of the ante wager may be collected for the house when one of the high player hand and the low player hand is composed of cards of the same rank as cards of a corresponding one of the high dealer hand and the low dealer hand, respectively, and the other of the high player hand and the low player hand includes a card of a different rank than each card of a corresponding other of the high dealer hand and the low dealer hand. In some embodiments, an entire amount of the ante wager, including the amount of any play wager added to the ante wager, may be collected for the house. In other embodiments, only a portion of the ante wager, which may or may not include the amount of any play wager added to the ante wager, may be collected for the house. For example, one part of a two-part ante wager, including the amount of any play wager added to the relevant part of the ante wager, may be collected for the house. Collecting at least a portion of the ante wager for the house may involve, for example, performing any of the acts described previously in connection with collecting the ante wager after accepting a player's election to fold.

In other embodiments, the amount of at least a portion of the ante wager may be returned to the player when one of the high player hand and the low player hand is composed of cards of the same rank as cards of a corresponding one of the corresponding high dealer hand and the corresponding low dealer hand even though the hands are of the same rank as one another and the wager would otherwise be a loss for the player. In other words, the wager associated with a particular hand comparison may push when at least one of the hand comparisons is a copy, and the other compared hand is not. For example, the amount of at least a portion of the ante wager may be returned to the player when the high player hand is composed of cards of the same rank as cards of the high dealer hand even though the hands are of the same rank as one another and the low player hand is outranked by the low dealer hand. As another example, the amount of at least a portion of the ante wager may be returned to the player when the high player hand is outranked by the high dealer hand and the low player hand is composed of cards of the same rank as the low dealer hand even though the hands are of the same rank as one another. In some embodiments, an entire amount of the ante wager, including the amount of any play wager added to the ante wager, may be returned to the player. In other embodiments, only a portion of the ante wager, which may or may not include the amount of any play wager added to the ante wager, may be returned to the player. For example, one part of a two-part ante wager, including the amount of any play wager added to the relevant part of the ante wager, may be returned to the player. Returning at least a portion of the ante wager to the player may involve, for example, performing any of the acts described previously in connection with returning at least a portion of the ante wager to the player when the player wins one hand comparison but loses the other hand comparison.

In some embodiments, the above-described rules applied to ties and copies may be switched with one another. For example, the house may win single copies, the player may win double copies, and single or double ties that are not copies may be wins for the house or pushes.

In some embodiments, a payout may be paid to the player on at least a portion of the ante wager to the player when one or both of the player hands includes a wild card, and at least a portion of the ante wager may be collected for the house when one or both of the dealer hands includes a wild card. In other words, dealing a wild card to a participant may result in an automatic win on one or more wagers for that participant. For example, the payout may be paid to the player on an entire amount of the ante wager, including the amount of any play wager added to the ante wager, when one or both of the player hands includes a wild card, and the entire amount of the ante wager, including the amount of any play wager added to the ante wager, may be collected for the house when one or both of the dealer hands includes a wild card. As another example, the payout may be paid to the player on one part of a two-part ante wager, including the amount of any play wager added to the relevant part of the ante wager, when one or both of the player hands includes a wild card, and one part of the two-part ante wager, including the amount of any play wager added to the relevant part of the ante wager, may be collected for the house when one or both of the dealer hands includes a wild card. An amount of the payout may be proportional to the amount risked in connection with the relevant portion of the ante wager in some embodiments. For example, the amount of the payout may be equal to or a multiple of the amounts risked in connection with the relevant portion of the ante wager (e.g., a 1:1 payout, 1:2 payout, 1:3 payout, 1:4 payout, etc.). Paying the payout may involve, for example, performing any of the acts described previously in connection with paying a payout on at least a portion of the ante wager. Collecting at least a portion of the ante wager for the house may involve, for example, performing any of the acts described previously in connection with collecting the ante wager after accepting a player's election to fold. In other embodiments, the wild card may simply be substituted for a card of any rank and suit to increase the likelihood that a hand including the wild card will win a comparison with a corresponding hand of another participant in the wagering game.

In some embodiments where the ante wager is a two-part wager, a payout may be paid to the player on at least a portion of the ante wager when the high player hand outranks the high dealer hand or the low player hand outranks the low dealer hand. For example, one part of a two-part ante wager may be assigned to one of the high hand and the low hand, and a payout may be paid to the player when a corresponding one of the rank of the high player hand is greater than the rank of the high dealer hand or the rank of the low player hand is greater than the rank of the low dealer hand. As another example, one part of a two-part ante wager may be assigned to the high hand and the other part of the two-part ante wager may be assigned to the low hand, and one payout may be paid to the player when the rank of the high player hand is greater than the rank of the high dealer hand and another payout may be paid to the player when the rank of the low player hand is greater than the rank of the low dealer hand. When the player loses a hand comparison associated with a given part of a two-part ante wager, the relevant part may be collected for the house. When a hand comparison associated with a given part of a two-part ante wager results in a push, the relevant part may be returned to the player.

In embodiments where a side wager was accepted from the player, a payout may be paid to the player on the side wager when the high player hand is a predetermined winning hand, the low player hand is a predetermined winning hand, or the high player hand and the low player hand are predetermined winning hands. For example, the payout on the side wager may be paid to the player when any hand held by the player is ranked a pair or better. An amount of the payout may increase as the ranks of the hands held by the player increase. For example, the payout on the side wager may be made according to the following pay table:

| Hand or Hands Achieved by the Player | Payout |
|---|---|
| Four of a Kind (i.e., all player cards are of the same rank) | 300:1 |
| Two Pair | 15:1 |
| Pair of Nines | 6:1 |
| Other Pairs | 1:1 |

When neither the high player hand nor the low player hand is a predetermined winning hand, an amount of the side wager may be collected for the house. For example, the amount of the side wager may be collected for the house when each hand held by the player is ranked lower than a pair.

In some embodiments, the game administrator may refrain from collecting a commission on each wager and each payout associated with the wagering game. In other words, all profits for the house may be obtained from lost wagers, and no house profits on this particular wagering game may be obtained by charging a commission on wagers or payouts (i.e., taking a “rake” or “raking” wagers or payouts).

Various platforms are contemplated that are suitable for implementation of embodiments of wagering games according to this disclosure. For example, embodiments of wagering games may be implemented as live table games with an in-person dealer, electronic gaming machines, partially or fully automated table games, and fully automated, network-administered games (e.g., Internet games) that either produce game results utilizing a processor, or produce a live video feed of a dealer administering a game from a remote studio.

As previously noted, any of the present methods and games may be played as a live casino table card game, as a hybrid casino table card game (with virtual cards or virtual chips), on a multi-player electronic platform (as disclosed in U.S. patent application Ser. No. 10/764,827, filed Jan. 26, 2004, published as U.S. Patent Application Publication No. 2005/0164759 on Jul. 28, 2005, now abandoned; U.S. patent application Ser. No. 10/764,994, filed Jan. 26, 2004, now U.S. Pat. No. 7,661,676, issued Feb. 16, 2010; and U.S. patent application Ser. No. 10/764,995, filed Jan. 26, 2004, now U.S. Pat. No. 8,272,958, issued Sep. 25, 2012; the disclosure of each of which applications and patents is incorporated herein in its entirety by this reference), on a personal computer for practice, on a hand-held game for practice, on a legally-authorized site on the Internet, or on a play-for-fun site on the Internet.

For example, in one embodiment, the players may be remotely located from a live dealer, and a live dealer and a game table may be displayed to players on their monitors via a video feed. The players' video feeds may be transmitted to the dealer and may also be shared among the players at the table. In a sample embodiment, a central station may include a plurality of betting-type game devices and an electronic camera for each game device. A plurality of player stations, remotely located with respect to the central station, may each include a monitor, for displaying a selected game device at the central station, and input means, for selecting a game device and for placing a bet by a player at the player's station relating to an action involving an element of chance to occur at the selected game device. Further details on gambling systems and methods for remotely-located players are disclosed in U.S. Pat. No. 6,755,741 B1, issued Jun. 29, 2004, titled “GAMBLING GAME SYSTEM AND METHOD FOR REMOTELY-LOCATED PLAYERS,” the disclosure of which is incorporated herein in its entirety by this reference.

Referring to FIG. 2, shown is a diagram of a playing surface 120 for implementation of wagering games within the scope of this disclosure. Such an implementation may be, for example, a felt layout on a physical gaming table 200 or 400 (see FIGS. 4, 6) or an electronic representation on a video display 374, 416, 430, 532, 564, 560, 658, or 688 (see FIGS. 5-7, 9, 10) for each participating player position 122. The playing surface 120 may include player positions 122 with which players may interact and a dealer position 124 with which the dealer may interact and within each of which the activity (e.g., wagering and card dealing) may take place. The dealer position 124 may be, for example, an area 124 which cards may be dealt to the dealer.

Referring to FIG. 3, illustrated is an enlarged diagram of one of the player positions of the playing surface of FIG. 2. Each player position 122 may include an area 126 within which cards may be dealt to the player. Each player position 122 may further include a first designated area 128 configured for accepting at least a portion of an ante wager, and in some embodiments for accepting a play wager. In some embodiments, each player position 122 may include a second designated area 130 configured for accepting a part of a two-part ante wager. In some embodiments, each player position 122 may include a third designated area 132 configured for accepting a side wager. In some embodiments, each player position 122 may include a fourth designated area 134 configured for accepting a play wager. Each of the first, second, third, and fourth designated areas 128 through 134 may be separate and distinct from one another. In some embodiments, each player position 120 may include pay tables 136 displaying payouts associated with one or more of the wagers.

The results of actions performed when administering wagering games in accordance with this disclosure may be reflected on the playing surface 132. For example, and referring collectively to FIGS. 2 and 3, at least one part of an ante wager may be accepted from a player, which may be reflected by the presence of a physical wagering element or the display of a computer-simulated wagering element in the first designated area 128. In some embodiments, another part of a two-part ante wager may be accepted from the player, which may be reflected by the presence of a physical wagering element or the display of a computer-simulated wagering element in the second designated area 130. In some embodiments, a side wager may be accepted from the player, which may be reflected by the presence of a physical wagering element or the display of a computer-simulated wagering element in the third designated area 132.

Four randomized cards may be dealt to each participating player and to dealer hands from a 52-card deck of standard playing cards, or from a 53-card deck including the 52 standard playing cards and one joker, which may be reflected by the presence of four physical cards or the display of four computer-simulated cards in the area 126 of each player position 122 and the presence of four physical cards or the display of four computer-simulated cards in the dealer position 124. The cards may be dealt face down, and players may be permitted to inspect their respective cards. In some embodiments, a play wager or an election to fold may be accepted from each player after each player has viewed the cards dealt to the respective player, which may be reflected by the presence of an additional physical wagering element or the display of an additional computer-simulated wagering element in a player's respective player position 122 (e.g., in the first designated area 128 or the fourth designated area 134) or by the physical removal of at least some wagering elements from or cessation of displaying at least some wagering elements within a player's respective player position 122 (e.g., from the first designated area 128 and the second designated area 130, when applicable).

A player's arrangement of the cards dealt to the player into a high player hand and a low player hand may be accepted, which may be reflected by the presence of each of two sets of two physical cards or the display of two sets of two computer-simulated cards in an arrangement selected by the player and accepted by the game administrator in the area 126 of a respective player position 122. Alternatively, the cards dealt to a player may be arranged into a high player hand and a low player hand by the dealer, which may be reflected by the presence of each of two sets of two physical cards or the display of two sets of two computer-simulated cards in an arrangement dictated by the house way for arranging cards in the area 126 of a respective player position 122. The cards dealt to the dealer may be arranged into a high dealer hand and a low dealer hand, which may be reflected by the presence of each of two sets of two physical cards or the display of two sets of two computer-simulated cards in an arrangement dictated by the house way for arranging cards in the dealer position 124.

At least one part of the ante wager, and any play wager, may be resolved by comparing the high player hand to the high dealer hand and the low player hand to the low dealer hand. A payout on the amount of the relevant portion of the ante wager, including the amount of any play wager, may be paid to the player when the high player hand outranks the high dealer hand and the low player hand outranks the low dealer hand, which may be reflected by the presence of physical wagering elements in the player position 122 or the electronic transfer of funds to a player account. In addition, a payout on the amount of the relevant portion of the ante wager, including the amount of any play wager, may be paid to the player when the high player hand is of a same rank as the high dealer hand and the low player hand is of the same rank as the low dealer hand, which may be reflected by the presence of physical wagering elements in the player position 122 or the electronic transfer of funds to a player account. In some embodiments, a payout on the amount of the relevant portion of the ante wager, including the amount of any play wager, may be paid to the player when one of the high player hand and the low player hand includes a wild card, which may be reflected by the presence of physical wagering elements in the player position 122 or the electronic transfer of funds to a player account.

At least a portion of the ante wager, including the amount of any play wager, may be collected for the house when the high player hand is outranked by the high dealer hand and the low player hand is outranked by the low dealer hand, which may be reflected by the physical removal of wagering elements from or cessation of displaying wagering elements within the first, second, and fourth designated areas 128, 130, and 134 of a player's respective player position 122. At least a portion of the ante wager, including the amount of any play wager, may be returned to the player when one of the high player hand and the low player hand outranks a corresponding one of the high dealer hand and the low dealer hand, and the other of the high player hand and the low player hand is outranked by a corresponding other of the high dealer hand and the low dealer hand, which may be reflected by moving the physical wagering elements associated with the relevant portion of the ante wager and any play wager closer to the player within the player position 122 or electronically transferring funds to a player account.

In some embodiments, at least a portion of the ante wager may be collected for the house when one of the high player hand and the low player hand is of the same rank as a corresponding one of the high dealer hand and the low dealer hand, and the other of the high player hand and the low player hand is of a different rank than a corresponding other of the high dealer hand and the low dealer hand, respectively, which may be reflected by the physical removal of wagering elements from or cessation of displaying wagering elements within the first, second, and fourth designated areas 128, 130, and 134 of a player's respective player position 122.

The side wager may be resolved by comparing the high player hand and the low player hand to a set of predetermined winning hands. A payout may be paid to the player on the side wager when the high player hand is a predetermined winning hand, the low player hand is a predetermined winning hand, or the high player hand and the low player hand are predetermined winning hands, which may be reflected by the presence of physical wagering elements in the player position 122 or the electronic transfer of funds to a player account. When neither of the player hands is a predetermined winning hand, the side wager may be collected for the house, which may be reflected by the physical removal of wagering elements from the third designated area 132 of a player's respective player position 122 to a rack 208 or 420 (see FIGS. 4, 6) or cessation of displaying wagering elements within the third designated area 132 of a player's respective player position 122.

As another example, the dealer may programs an automatic card shuffler such as the device described in U.S. Pat. No. 8,070,574, the content of which is incorporated by reference in its entirety, to deliver packs of four cards each to each player and the dealer. The dealer accepts an ante in betting circle 128 to participate in the game, and a bonus side bet in betting circle 132 to optionally participate in a side bet game. The dealer distributes the packs of four cards to each player and the dealer. The dealer sets his hand into a two-card high hand and a two-card low hand. Each player either sets his four cards into a two-card high hand and two-card low hand or the dealer assists in administering the game by setting the hands. The dealer may utilize an electronic device that communicates with the shuffler to assist in setting the hand the house way, as is disclosed in U.S. Pat. No. 8,342,529, and is hereby incorporated by reference in its entirety. The house way may require the dealer to set the dealer hands a house way, including placing higher ranking pairs in the high hand if he is dealt two pairs, or to put a single pair in the high hand if dealt one pair. If dealt no pairs, the dealer may be required to maximize the low hand while still having a stronger high hand, according to house rules. The player may be prohibited from splitting pairs, and must put the stronger hand in the high hand, otherwise the dealer may call a foul and collect the wagers.

After accepting all wagers and setting hands, the dealer may compare the player's high hand and dealer's high hand, and the player's low hand and the dealer's low hand. If both player hands outrank both dealer hands, the player may win 1:1 on the ante wager. If the dealer hands both outrank the player hands, the house may take the ante. If both high hands or both low hands are ties, while the other of the high hands and low hands are not ties, the house may take the ante. If both the high hands and both low hands are ties, the player may win an odds payout, such as 4:1 on the ante. Hands may be ranked with a pair of aces being the highest ranking hand, down to a pair of twos, followed by baccarat point values modulo 10, with a hand value of nine being lower than a pair of twos, followed by a hand value of eight, down to a hand value of zero.

If the player made the side wager, the side wager may pay if the player holds at least one pair. Payouts may be made according to the following pay table:

| Hand | Payout Odds |
|---|---|
| Four of a Kind | 300 to 1 |
| Two Pair | 15 to 1 |
| Pair of Nines | 6 to 1 |
| Other Pairs | 1 to 1 |

In some embodiments, the wagering games described herein may be played against a game administrator (i.e., against “the house” such that the game is “house-banked”). Such implementations may involve the game administrator (e.g., a casino or other gaming establishment) accepting (e.g., via a dealer or other agent of the administrator) wagers of real-world monetary value, distributing payouts of real-world monetary value on winning wagers to players, and collecting real-world monetary value of lost wagers. Such “house-banked” embodiments may be implemented in the form of a live table game, in a virtual table game, in an electronic game, or in an online game configuration.

In other embodiments, the wagering games, or at least one wager associated with the wagering games, may involve a player in a casino or other gaming establishment acting as banker, accepting wagers having real-world monetary value, issuing payouts having real-world monetary value, and collecting real-world monetary value of lost wagers (i.e., be “player-banked”). In some embodiments where at least one wager is player-banked, the game administrator may collect a player entrance fee, or a rake on each player-banked wager accepted from the participating players, including the banker.

FIG. 4 is a perspective view of an embodiment of a gaming table 200 for implementing wagering games in accordance with this disclosure. The gaming table 200 may be a physical article of furniture around which participants in the wagering game may stand or sit and on which the physical objects used for administering and otherwise participating in the wagering game may be supported, positioned, moved, transferred, and otherwise manipulated. For example, the gaming table 200 may include a gaming surface 202 on which the physical objects used in administering the wagering game may be located. The gaming surface 202 may be, for example, a felt fabric covering a hard surface of the table, and a design, conventionally referred to as a “layout,” specific to the game being administered may be physically printed on the gaming surface 202. As another example, the gaming surface 202 may be a surface of a transparent or translucent material (e.g., glass or plexiglass) onto which a projector 203, which may be located, for example, above or below the gaming surface 202, may illuminate a layout specific to the wagering game being administered. In such an example, the specific layout projected onto the gaming surface 202 may be changeable, enabling the gaming table 200 to be used to administer different variations of wagering games within the scope of this disclosure or other wagering games. Additional details of illustrative gaming surfaces and projectors are disclosed in U.S. patent application Ser. No. 13/919,849, filed Jun. 17, 2013, and titled “ELECTRONIC GAMING DISPLAYS, GAMING TABLES INCLUDING ELECTRONIC GAMING DISPLAYS AND RELATED ASSEMBLIES, SYSTEMS AND METHODS,” the disclosure of which is incorporated herein in its entirety by this reference. In either example, the gaming surface 202 may include, for example, designated areas for player positions; areas in which one or more of player cards, dealer cards, or community cards may be dealt; areas in which wagers may be accepted; areas in which wagers may be grouped into pots; and areas in which rules, pay tables, and other instructions related to the wagering game may be displayed. As a specific, nonlimiting example, the gaming surface 202 may be configured as shown in FIGS. 2 and 3.

In some embodiments, the gaming table 200 may include a display 210 separate from the gaming surface 202. The display 210 may be configured to face players, prospective players, and spectators and may display, for example, rules, paytables, real-time game status, such as wagers accepted and cards dealt, historical game information, such as amounts won, amounts wagered, percentage of hands won, and notable hands achieved, and other instructions and information related to the wagering game. The display 210 may be a physically fixed display, such as a poster, in some embodiments. In other embodiments, the display 210 may change automatically in response to a stimulus (e.g., may be an electronic video monitor).

The gaming table 200 may include particular machines and apparatuses configured to facilitate the administration of the wagering game. For example, the gaming table 200 may include one or more card-handling devices 204. The card-handling device 204A may be, for example, a shoe from which physical cards 206 from one or more decks of playing cards may be withdrawn, one at a time. Such a card-handling device 204A may include a housing in which cards 206 are located, an opening from which cards 206 are removed, and a card-presenting mechanism (e.g., a moving weight on a ramp configured to push a stack of cards down the ramp) configured to continually present new cards 206 for withdrawal from the shoe. Additional details of an illustrative card-handling device 204A configured as a shoe are found in U.S. Patent App. Pub. No. 2010/0038849, published Feb. 18, 2010, and titled “INTELLIGENT AUTOMATIC SHOE AND CARTRIDGE,” the disclosure of which is incorporated herein in its entirety by this reference. The card-handling device 204B may be, for example, a shuffler configured to reorder physical cards 206 from one or more decks of playing cards and present randomized cards 206 for use in the wagering game. Such a card-handling device 204B may include a housing, a shuffling mechanism configured to shuffle cards, and card inputs and outputs (e.g., trays). Additional details of an illustrative card-handling device 204B configured as a shuffler are found in U.S. Pat. No. 8,070,574, issued Dec. 6, 2011, to Grauzer et al., the disclosure of which is incorporated herein in its entirety by this reference. The card-handling device 204 may also be, for example, a combination shuffler and shoe in which the output for the shuffler is a shoe. The card-handling device 204 may simply be supported on the gaming surface 202 in some embodiments. In other embodiments, the card-handling device 204 may be mounted to the gaming table 202 such that the card-handling device 204 is not manually removable from the gaming table 202 without the use of tools. In some embodiments, the deck or decks of playing cards used may be standard, 52-card decks. In other embodiments, the deck or decks used may include cards, such as, for example, jokers, wild cards, bonus cards, etc.

In some embodiments, the card-handling device 204 may include an electronic display 207 for displaying information related to the wagering game being administered. For example, the electronic display 207 may display a menu of game options, the game selected, the number of cards per hand to be dispensed, acceptable amounts for wagers (e.g., maximums and minimums), numbers of cards to be dealt to recipients, locations of particular recipients for particular cards, winning and losing wagers, pay tables, and payout amounts. In other embodiments, information related to the wagering game may be displayed on another electronic display, such as, for example, the display 210 described previously.

The type of card-handling device 204 employed to administer embodiments of the disclosed wagering game, as well as the type of card deck employed and the number of decks, may be specific the game to be implemented. For example, the card-handling device 204 may be configured to shuffle at least a physical deck of 52 standard playing cards. In some embodiments, additional cards may further be included in the deck, such as, for example, bonus cards (e.g., granting an automatic payout upon dealing and redemption or granting a prize or other award upon dealing and redemption) or wild cards (e.g., jokers). As a specific, nonlimiting example, the card-handling device 204 may be a card shuffler or a combination card shuffler and shoe configured to randomize and present cards (e.g., in groups or one at a time) from a deck including one or more sets of 52 standard playing cards, at least one joker, and, optionally, one or more bonus cards.

The gaming table 200 may include one or more chip racks 208 configured to facilitate accepting wagers, transferring lost wagers to the house, and exchanging monetary value for wagering elements 212 (e.g., chips). For example, the chip rack 208 may include a series of token support rows, each of which may support tokens of a different type (e.g., color and denomination). In some embodiments, the chip rack 208 may be configured to automatically present a selected number of chips using a chip-cutting-and-delivery mechanism. Additional details of an illustrative chip rack 208 and chip-cutting-and-delivery mechanism are found in U.S. Pat. No. 7,934,980, issued May 3, 2011, to Blaha et al., the disclosure of which is incorporated herein in its entirety by this reference. In some embodiments, the gaming table 200 may include a drop box 214 for money that is accepted in exchange for wagering elements 212. The drop box 214 may be, for example, a secure container (e.g., a safe or lockbox) having a one-way opening into which money may be inserted and a secure, lockable opening from which money may be retrieved. Such drop boxes 214 are known in the art and may be incorporated directly into the gaming table 200 and may, in some embodiments, have a removable container for the retrieval of money in a separate, secure location.

When administering a wagering game in accordance with embodiments of this disclosure, a dealer 216 may receive money (e.g., cash) from a player in exchange for wagering elements 212. The dealer 216 may deposit the money in the deposit 214 and transfer physical wagering elements 212 to the player. The dealer 216 may accept one or more initial wagers (e.g., antes and other wagers) from the player, which may be reflected by the dealer 216 permitting the player to place one or more wagering tokens 212 or other wagering elements (e.g., cash) within designated areas on the gaming surface 202 associated with the various wagers of the wagering game. Once initial wagers have been accepted, the dealer 216 may remove physical cards 206 from the card-handling device 204 and position them within designated areas on the gaming surface 202, which may designate the cards 206 for use as individual player cards, community cards, or dealer cards in accordance with game rules.

After dealing the cards 206, and during play, according to the game rules, any additional wagers (e.g., play bets) may be accepted, which may be reflected by the dealer 216 permitting the player to place one or more wagering tokens 212 within designated areas on the gaming surface 202 associated with the various wagers of the wagering game. In some embodiments, a player may fold, which may result in the dealer 216 collecting at least one of the wagering tokens 212 from that player and transferring it to the house, which may be reflected by the wagering token 212 being returned to the chip rack 208. The dealer 216 may perform any additional card dealing and rounds of betting permitted in the wagering game. Finally, the dealer 216 may resolve the wagers, award winning wagers to the players, which may be accomplished by giving wagering tokens 212 from the chip rack 208 to the players, and transferring losing wagers to the house, which may be accomplished by moving wagering tokens 212 from the players to the chip rack 208. House rules also may allow the player to place wagers during card distribution, or after card distribution, but before revealing the cards.

FIG. 5 is a perspective view of an individual electronic gaming device 300 (e.g., an electronic gaming machine (EGM)) configured for implementing wagering games according to this disclosure. The individual electronic gaming device 300 may include an individual player position 314 including a player input area 332 configured to enable a player to interact with the individual electronic gaming device 300 through various input devices (e.g., buttons, levers, touchscreens). The individual electronic gaming device 300 may include a gaming screen 374 configured to display indicia for interacting with the individual electronic gaming device 300, such as through processing one or more programs stored in memory 340 to implement the rules of game play at the individual electronic gaming device 300. Accordingly, game play may be accommodated without involving physical playing cards, chips or other wagering elements, and live personnel. The action may instead be simulated by a control processor 350 operably coupled to the memory 340 and interacting with and controlling the individual electronic gaming device 300.

Although the individual electronic gaming device 300 displayed in FIG. 5 has an outline of a traditional gaming cabinet, the individual electronic gaming device 300 may be implemented in other ways, such as, for example, client software downloaded to a portable device, such as a smart phone, tablet, or laptop computer. The individual electronic gaming device 300 may also be a non-portable personal computer (e.g., a desktop or all-in-one computer) or other computing device. In some embodiments, client software is not downloaded but is native to the device or is otherwise delivered with the device when distributed.

A communication device 360 may be included and operably coupled to the processor 350 such that information related to operation of the individual electronic gaming device 300, information related to the game play, or combinations thereof may be communicated between the individual electronic gaming device 300 and other devices, such as a server, through a suitable communication medium, such, as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners to communicate rules of game play and the like, such as along a top portion 378 of the cabinet 376 of the individual electronic gaming device 300. The individual electronic gaming device 300 may further include additional decorative lights (not shown), and speakers (not shown) for transmitting and optionally receiving sounds during game play. Further detail of an example of an individual electronic gaming device 300 (as well as other embodiments of tables and devices) is disclosed in U.S. patent application Ser. No. 13/963,165, filed Aug. 9, 2013, and titled “METHODS AND SYSTEMS FOR ELECTRONIC GAMING” the disclosure of which is incorporated herein in its entirety by this reference.

Some embodiments may be implemented at locations including a plurality of player stations. Such player stations may include an electronic display screen for display of game information (e.g., cards, wagers, and game instructions) and for accepting wagers and facilitating credit balance adjustments. Such player stations may, optionally, be integrated in a table format, may be distributed throughout a casino or other gaming site, or may include both grouped and distributed player stations.

FIG. 6 is a top view of a suitable table 400 configured for implementing wagering games according to this disclosure. The table 400 may include a playing surface 404. The table 400 may include player stations 412. Each player station 412 may include a player interface 416, which may be used for displaying game information (e.g., game instructions, input options, wager information, game outcomes, etc.) and accepting player elections. The player interface 416 may be a display screen in the form of a touch screen, which may be at least substantially flush with the playing surface 404 in some embodiments. Each player interface 416 may be operated by its own local game processor 414 (shown in dashed lines), although, in some embodiments, a central game processor 428 (shown in dashed lines) may be employed and may communicate directly with player interfaces 416. In some embodiments, a combination of individual local game processors 414 and the central game processor 428 may be employed.

A communication device 460 may be included and may be operably coupled to one or more of the local game processors 414, the central game processor 428, or combinations thereof, such that information related to operation of the table 400, information related to the game play, or combinations thereof may be communicated between the table 400 and other devices through a suitable communication medium, such as, for example, wired networks, Wi-Fi networks, and cellular communication networks.

The table 400 may further include additional features, such as a dealer chip tray 420, which may be used by the dealer to cash players in and out of the wagering game, whereas wagers and balance adjustments during game play may be performed using, for example, virtual chips (e.g., images or text representing wagers). For embodiments using physical cards 406a and 406b, the table 400 may further include a card-handling device 422, which may be configured to shuffle, read, and deliver physical cards for the dealer and players to use during game play or, alternatively, a card shoe configured to read and deliver cards that have already been randomized. For embodiments using virtual cards, the virtual cards may be displayed at the individual player interfaces 416. Common virtual cards may be displayed in a common card area.

The table 400 may further include a dealer interface 418, which, like the player interfaces 416, may include touch screen controls for receiving dealer inputs and for assisting the dealer in administering the wagering game. The table 400 may further include an upright display 430 configured to display images that depict game information such as pay tables, hand counts, historical win/loss information by player, and a wide variety of other information considered useful to the players. The upright display 430 may be double sided to provide such information to players as well as to casino pit personnel.

Further detail of an example of a table and player displays is disclosed in U.S. Pat. No. 8,262,475, issued Sep. 11, 2012, and titled “CHIPLESS TABLE SPLIT SCREEN FEATURE,” the disclosure of which is incorporated herein in its entirety by this reference. Although an embodiment is described showing individual discrete player stations, in some embodiments, the entire playing surface 404 may be an electronic display that is logically partitioned to permit game play from a plurality of players for receiving inputs from, and displaying game information to, the players, the dealer, or both.

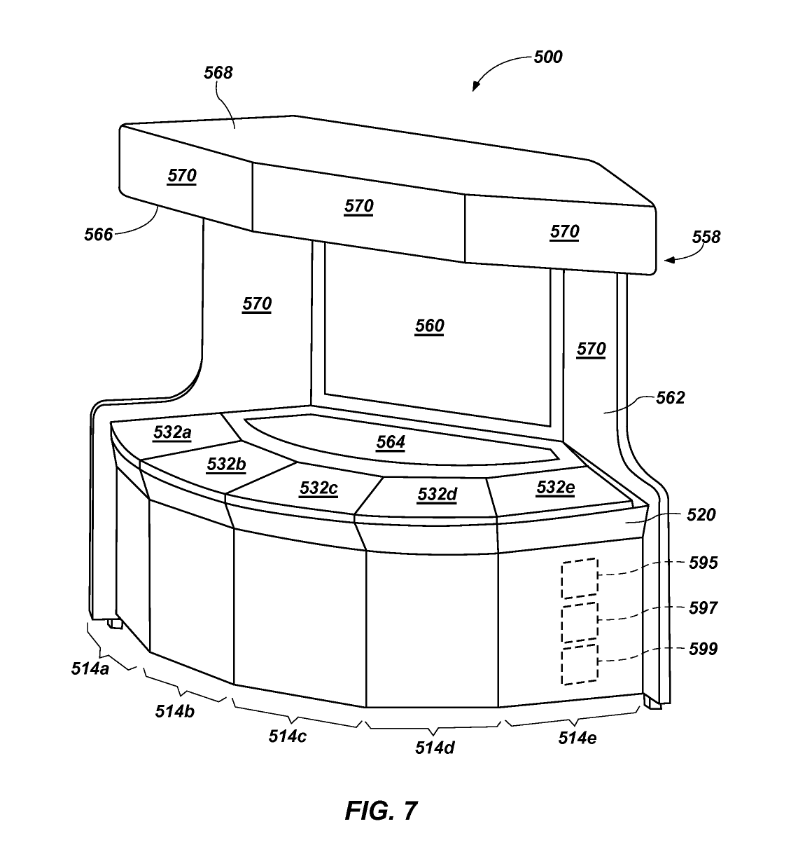

FIG. 7 is a perspective view of another embodiment of a suitable table 500 configured for implementing wagering games according to the present disclosure utilizing a virtual dealer. The table 500 may include player positions 514 arranged in a bank about an arcuate edge 520 of a video device 558 that may comprise a card screen 564 and a dealer screen 560. The dealer screen 560 may display a video simulation of the dealer (i.e., a virtual dealer) for interacting with the video device 558, such as through processing one or more stored programs stored in memory 595 to implement the rules of game play at the video device 558. The dealer screen 560 may be carried by a generally vertically extending cabinet 562 of the video device 558. The card screen 564 may be configured to display at least one or more of the dealer's cards, any community cards, and player's cards by the virtual dealer on the dealer screen 560.

Each of the player positions 514 may include a player interface area 532 configured for wagering and game play interactions with the video device 558 and virtual dealer. Accordingly, game play may be accommodated without involving physical playing cards, poker chips, and live personnel. The action may instead be simulated by a control processor 597 interacting with and controlling the video device 558. The control processor 597 may be programmed, by known techniques, to implement the rules of game play at the video device 558. As such, the control processor 597 may interact and communicate with display/input interfaces and data entry inputs for each player interface area 532 of the video device 558. Other embodiments of tables and gaming devices may include a control processor that may be similarly adapted to the specific configuration of its associated device.

A communication device 599 may be included and operably coupled to the control processor 597 such that information related to operation of the table 500, information related to the game play, or combinations thereof may be communicated between the table 500 and other devices, such as a central server, through a suitable communication medium, such, as, for example, wired networks, Wi-Fi networks, and cellular communication networks.

The video device 558 may further include banners communicating rules of play and the like, which may be located along one or more walls 570 of the cabinet 562. The video device 558 may further include additional decorative lights and speakers, which may be located on an underside surface 566, for example, of a generally horizontally extending top 568 of the cabinet 562 of the video device 558 generally extending toward the player positions 514.

Further detail of an example of a table and player displays is disclosed in U.S. Pat. No. 8,272,958, issued Sep. 25, 2012, and titled “AUTOMATED MULTIPLAYER GAME TABLE WITH UNIQUE IMAGE FEED OF DEALER,” the disclosure of which is incorporated herein in its entirety by this reference. Although an embodiment is described showing individual discrete player stations, in some embodiments, the entire playing surface (e.g., player interface areas 532, card screen 564, etc.) may be a unitary electronic display that is logically partitioned to permit game play from a plurality of players for receiving inputs from, and displaying game information to, the players, the dealer, or both.

In some embodiments, wagering games in accordance with this disclosure may be administered using a gaming system employing a client-server architecture (e.g., over the Internet, a local area network, etc.). FIG. 8 is a schematic block diagram of an illustrative gaming system 600 for implementing wagering games according to this disclosure. The gaming system 600 may enable end users to remotely access game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not limited to, Class II and Class III games as defined under 25 U.S.C. §2701 et seq. (“Indian Gaming Regulatory Act”). Such games may include banked and/or non-banked games.

The wagering games supported by the gaming system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 600 may include a gaming platform to establish a portal for an end user to access a wagering game hosted by one or more gaming servers 610 over a network 630. In some embodiments, games are accessed through a user interaction service 612. The gaming system 600 enables players to interact with a user device 620 through a user input device 624 and a display 622 and to communicate with one or more gaming servers 610 using a network 630 (e.g., the Internet). Typically the user device is remote from the gaming server 610 and the network is the word-wide web (i.e., Internet).

In some embodiments, the gaming servers 610 may be configured as a single server to administer wagering games in combination with the user device 620. In other embodiments, the gaming servers 610 may be configured as separate servers for performing separate, dedicated functions associated with administering wagering games. Accordingly, the following description also discusses “services” with the understanding that the various services may be performed by different servers or combinations of servers in different embodiments. As shown in FIG. 8, the gaming servers 610 may include a user interaction service 612, a game service 616, and an asset service 614. In some embodiments, one or more of the gaming servers 610 may communicate with an account server 632 performing an account service 632. As explained more fully below, for some wagering type games, the account service 632 may be separate and operated by a different entity than the gaming servers 610; however, in some embodiments the account service 632 may also be operated one or more of the gaming servers 610.

The user device 620 may communicate with the user interaction service 612 through the network 630. The user interaction service 612 may communicate with the game service 616 and provide game information to the user device 620. In some embodiments, the game service 616 may also include a game engine. The game engine may, for example, access, interpret, and apply game rules. In some embodiments, a single user device 620 communicates with a game provided by the game service 616, while other embodiments may include a plurality of user devices 620 configured to communicate and provide end users with access to the same game provided by the game service 616. In addition, a plurality of end users may be permitted to access a single user interaction service 612, or a plurality of user interaction services 612, to access the game service 616. The user interaction service 612 may enable a user to create and access a user account and interact with game service 616. The user interaction service 612 may enable users to initiate new games, join existing games, and interface with games being played by the user.

The user interaction service 612 may also provide a client for execution on the user device 620 for accessing the gaming servers 610. The client provided by the gaming servers 610 for execution on the user device 620 may be any of a variety of implementations depending on the user device 620 and method of communication with the gaming servers 610. In one embodiment, the user device 620 may connect to the gaming servers 610 using a web browser, and the client may execute within a browser window or frame of the web browser. In another embodiment, the client may be a stand-alone executable on the user device 620.

For example, the client may comprise a relatively small amount of script (e.g., JAVASCRIPT®), also referred to as a “script driver,” including scripting language that controls an interface of the client. The script driver may include simple function calls requesting information from the gaming servers 610. In other words, the script driver stored in the client may merely include calls to functions that are externally defined by, and executed by, the gaming servers 610. As a result, the client may be characterized as a “thin client.” The client may simply send requests to the gaming servers 610 rather than performing logic itself. The client may receive player inputs, and the player inputs may be passed to the gaming servers 610 for processing and executing the wagering game. In some embodiments, this may involve providing specific graphical display information for the display 622 as well as game outcomes.

As another example, the client may comprise an executable file rather than a script. The client may do more local processing than does a script driver, such as calculating where to show what game symbols upon receiving a game outcome from the game service 616 through user interaction service 612. In some embodiments, portions of an asset service 614 may be loaded onto the client and may be used by the client in processing and updating graphical displays. Some form of data protection, such as end-to-end encryption, may be used when data is transported over the network 630. The network 630 may be any network, such as, for example, the Internet or a local area network.

The gaming servers 610 may include an asset service 614, which may host various media assets (e.g., text, audio, video, and image files) to send to the user device 620 for presenting the various wagering games to the end user. In other words, the assets presented to the end user may be stored separately from the user device 620. For example, the user device 620 requests the assets appropriate for the game played by the user; as another example, especially relating to thin clients, just those assets that are needed for a particular display event will be sent by the gaming servers 610, including as few as one asset. The user device 620 may call a function defined at the user interaction service 612 or asset service 614, which may determine which assets are to be delivered to the user device 620 as well as how the assets are to be presented by the user device 620 to the end user. Different assets may correspond to the various user devices 620 and their clients that may have access to the game service 616 and to different variations of wagering games.

The gaming servers 610 may include the game service 616, which may be programmed to administer wagering games and determine game play outcomes to provide to the user interaction service 612 for transmission to the user device 620. For example, the game service 616 may include game rules for one or more wagering games, such that the game service 616 controls some or all of the game flow for a selected wagering game as well as the determined game outcomes. The game service 616 may include pay tables and other game logic. The game service 616 may perform random number generation for determining random game elements of the wagering game. In one embodiment, the game service 616 may be separated from the user interaction service 612 by a firewall or other method of preventing unauthorized access to the game service 612 by the general members of the network 630.

The user device 620 may present a gaming interface to the player and communicate the user interaction from the user input device 624 to the gaming servers 610. The user device 620 may be any electronic system capable of displaying gaming information, receiving user input, and communicating the user input to the gaming servers 610. For example, the user device 620 may be a desktop computer, a laptop, a tablet computer, a set-top box, a mobile device (e.g., a smartphone), a kiosk, a terminal, or another computing device. As a specific, nonlimiting example, the user device 620 operating the client may be an interactive electronic gaming system 300 (see FIG. 5), as described above. The client may be a specialized application or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 610. The client may be illustrated within a casino webpage (or other interface) indicating that the client is embedded into a webpage, which is supported by a web browser executing on the user device 620.

In some embodiments, components of the gaming system 600 may be operated by different entities. For example, the user device 620 may be operated by a third party, such as a casino or an individual, that links to the gaming servers 610, which may be operated, for example, by a wagering game service provider. Therefore, in some embodiments, the user device 620 and client may be operated by a different administrator than the operator of the game service 616. In other words, the user device 620 may be part of a third-party system that does not administer or otherwise control the gaming servers 610 or game service 616. In other embodiments, the user interaction service 612 and asset service 614 may be operated by a third-party system. For example, a gaming entity (e.g., a casino) may operate the user interaction service 612, user device 620, or combination thereof to provide its customers access to game content managed by a different entity that may control the game service 616, amongst other functionality. In still other embodiments, all functions may be operated by the same administrator. For example, a gaming entity (e.g., a casino) may elect to perform each of these functions in-house, such as providing access to the user device 620, delivering the actual game content, and administering the gaming system 600.

The gaming servers 610 may communicate with one or more external account servers 632 (also referred to herein as an account service 632), optionally through another firewall. For example, the gaming servers 610 may not directly accept wagers or issue payouts. That is, the gaming servers 610 may facilitate online casino gaming but may not be part of a self-contained online casino itself. Another entity (e.g., a casino or any account holder or financial system of record) may operate and maintain its external account service 632 to accept bets and make payout distributions. The gaming servers 610 may communicate with the account service 632 to verify the existence of funds for wagering and to instruct the account service 632 to execute debits and credits. As another example, the gaming servers 610 may directly accept bets and make payout distributions, such as in the case where an administrator of the gaming servers 610 operates as a casino.

Additional features may be supported by the gaming servers 610, such as hacking and cheating detection, data storage and archival, metrics generation, messages generation, output formatting for different end user devices, as well as other features and operations. For example, the gaming servers 610 may include additional features and configurations as described in U.S. patent application Ser. No. 13/353,194, filed Jan. 18, 2012, and U.S. patent application Ser. No. 13/609,031, filed Sep. 10, 2012, both applications titled “NETWORK GAMING ARCHITECTURE, GAMING SYSTEMS, AND RELATED METHODS,” the disclosure of each of which is incorporated herein in its entirety by this reference.

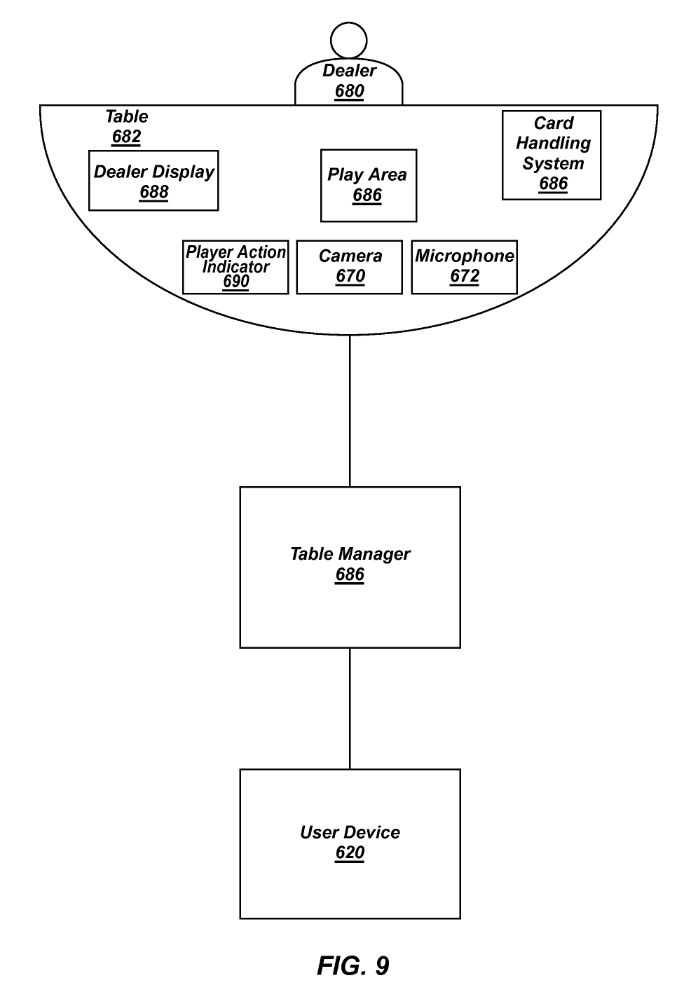

FIG. 9 is a schematic block diagram of a table 682 for implementing wagering games including a live dealer feed. Features of the gaming system 600 (see FIG. 8) described above in connection with FIG. 8 may be utilized in connection with this embodiment, except as further described. Rather than cards being determined by a computerized random processes, physical cards (e.g., from a standard, 52-card deck of playing cards) may be dealt by a live dealer 680 at a table 682 from a card handling system 684. A table manager 686 may assist the dealer 680 in facilitating play of the game by transmitting a video feed of the dealer's actions to the user device 620 and transmitting player elections to the dealer 680. As described above, the table manager 686 may act as or communicate with a gaming system 600 (see FIG. 8) (e.g., acting as the gaming system 600 (see FIG. 8) itself or as an intermediate client interposed between and operationally connected to the user device 620 and the gaming system 600 (see FIG. 8)) to provide gaming at the table 682 to users of the gaming system 600 (see FIG. 8). Thus, the table manager 686 may communicate with the user device 620 through a network 630 (see FIG. 8), and may be a part of a larger online casino, or may be operated as a separate system facilitating game play. In various embodiments, each table 682 may be managed by an individual table manager 686 constituting a gaming device, which may receive and process information relating to that table. For simplicity of description, these functions are described as being performed by the table manager 686, though certain functions may be performed by an intermediary gaming system 600 (see FIG. 8), such as the one shown and described in connection with FIG. 8. In some embodiments, the gaming system 600 (see FIG. 8) may match remotely located players to tables 682 and facilitate transfer of information between user devices 620 and tables 682, such as wagering amounts and player option elections, without managing gameplay at individual tables. In other embodiments, functions of the table manager 686 may be incorporated into a gaming system 600 (see FIG. 8).

The table 682 includes a camera 670 and optionally a microphone 672 to capture video and audio feeds relating to the table 682. The camera 670 may be trained on the dealer 680, play area 687, and card handling system 684. As the game is administered by the dealer 680, the video feed captured by the camera 670 may be shown to the player using the user device 620, and any audio captured by the microphone 672 may be played to the player using the user device 620. In some embodiments, the user device 620 may also include a camera, microphone, or both, which may also capture feeds to be shared with the dealer 680 and other players. In some embodiments, the camera 670 may be trained to capture images of the card faces, chips, and chip stacks on the surface of the gaming table. Known image extraction techniques may be used to obtain card count and card rank and suit information from the card images. An example of suitable image extraction software is disclosed in U.S. Pat. No. 7,901,285, issued Mar. 8, 2011, to Tran et al., the disclosure of which is incorporated in this disclosure in its entirety by this reference.

Card and wager data in some embodiments may be used by the table manger 686 to determine game outcome. The data extracted from the camera 670 may be used to confirm the card data obtained from the card handling system 684, to determine a player position that received a card, and for general security monitoring purposes, such as detecting player or dealer card switching, for example. Examples of card data include, for example, suit and rank information of a card, suit and rank information of each card in a hand, rank information of a hand, and rank information of every hand in a round of play.

The live video feed permits the dealer to show cards dealt by the card handling system and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

The card handling system 684 may be as shown and described previously in connection with FIG. 4. The play area 686 depicts player positions for playing the game, such as shown in FIGS. 2 and 3. As determined by the rules of the game, the player at the user device 620 may be presented options for responding to an event in the game using a client as described with reference to FIG. 8.

Player elections may be transmitted to the table manager 686, which may display player elections to the dealer 680 using a dealer display 688 and player action indicator 690 on the table 682. For example, the dealer display 688 may display information regarding where to deal the next card or which player position is responsible for the next action.

In some embodiments, the table manager 686 may receive card information from the card handling system 684 to identify cards dealt by the card handling system 684. For example, the card handling system 684 may include a card reader to determine card information from the cards. The card information may include the rank and suit of each dealt card and hand information.

The table manager 686 may apply game rules to the card information, along with the accepted player decisions, to determine gameplay events and wager results. Alternatively, the wager results may be determined by the dealer 680 and input to the table manager 686, which may be used to confirm automatically determined results by the gaming system.

Card and wager data in some embodiments may be used by the table manger 686 to determine game outcome. The data extracted from the camera 670 may be used to confirm the card data obtained from the card handling system 684, to determine a player position that received a card, and for general security monitoring purposes, such as detecting player or dealer card switching, for example.

The live video feed permits the dealer to show cards dealt by the card handling system and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

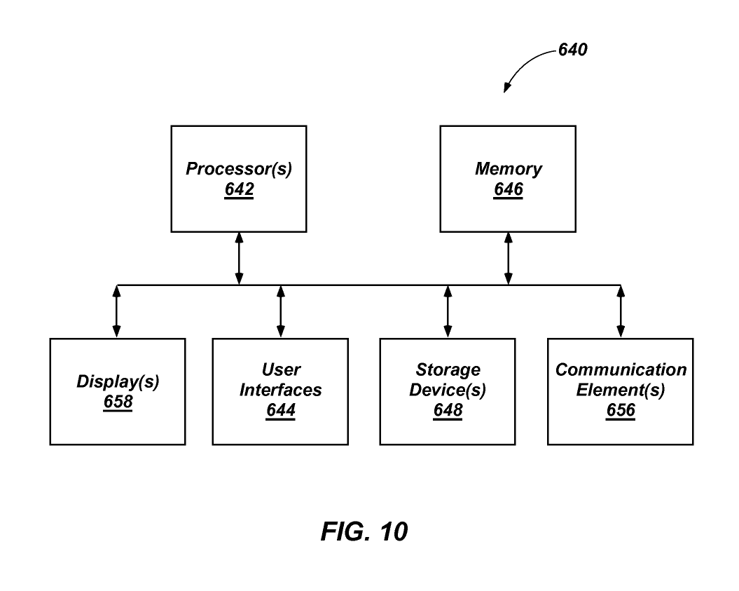

FIG. 10 is a simplified block diagram showing elements of computing devices that may be used in systems and apparatuses of this disclosure. The computing system 640 may be a user-type computer, a file server, a computer server, a notebook computer, a tablet, a handheld device, a mobile device, or other similar computer system for executing software. The computing system 640 may be configured to execute software programs containing computing instructions and may include one or more processors 642, memory 646, one or more displays 658, one or more user interface elements 644, one or more communication elements 656, and one or more storage devices 648 (also referred to herein simply as storage 648).

The processors 642 may be configured to execute a wide variety of operating systems and applications including the computing instructions for administering wagering games of the present disclosure.

The memory 646 may be used to hold computing instructions, data, and other information for performing a wide variety of tasks including administering wagering games of the present disclosure. By way of example, and not limitation, the memory 646 may include Synchronous Random Access Memory (SRAM), Dynamic RAM (DRAM), Read-Only Memory (ROM), Flash memory, and the like.

The display 658 may be a wide variety of displays such as, for example, light emitting diode displays, liquid crystal displays, cathode ray tubes, and the like. In addition, the display 658 may be configured with a touch-screen feature for accepting user input as a user interface element 644.

As non-limiting examples, the user interface elements 644 may include elements such as displays, keyboards, push-buttons, mice, joysticks, haptic devices, microphones, speakers, cameras, and touchscreens.

As non-limiting examples, the communication elements 656 may be configured for communicating with other devices or communication networks. As non-limiting examples, the communication elements 656 may include elements for communicating on wired and wireless communication media, such as for example, serial ports, parallel ports, Ethernet connections, universal serial bus (USB) connections, IEEE 1394 (“firewire”) connections, Thunderbolt™ connections, Bluetooth® wireless networks, ZigBee wireless networks, 802.11 type wireless networks, cellular telephone/data networks, and other suitable communication interfaces and protocols.

The storage 648 may be used for storing relatively large amounts of nonvolatile information for use in the computing system 640 and may be configured as one or more storage devices. By way of example, and not limitation, these storage devices may include computer-readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 640 may be configured in many different ways with different types of interconnecting buses between the various elements. Moreover, the various elements may be subdivided physically, functionally, or a combination thereof. As one nonlimiting example, the memory 646 may be divided into cache memory, graphics memory, and main memory. Each of these memories may communicate directly or indirectly with the one or more processors 642 on separate buses, partially-combined buses, or a common bus.

In some embodiments, wagering games may be administered in an at least partially player-pooled format, with payouts on pooled wagers being paid from a pot to players and losses on wagers being collected into the pot and eventually distributed to one or more players. Such player-pooled embodiments may include a player-pooled progressive embodiment, in which a pot is eventually distributed when a predetermined progressive-winning hand combination or composition is dealt. Player-pooled embodiments may also include a dividend refund embodiment, in which at least a portion of the pot is eventually distributed in the form of a refund distributed, e.g., pro-rata, to the players who contributed to the pot.

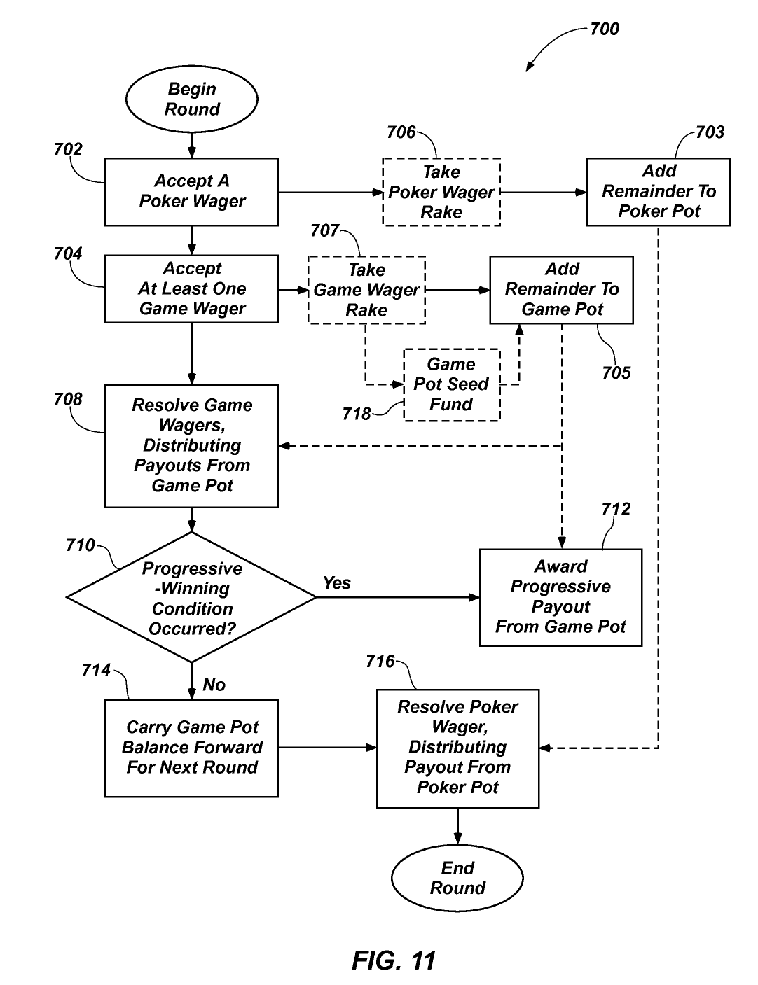

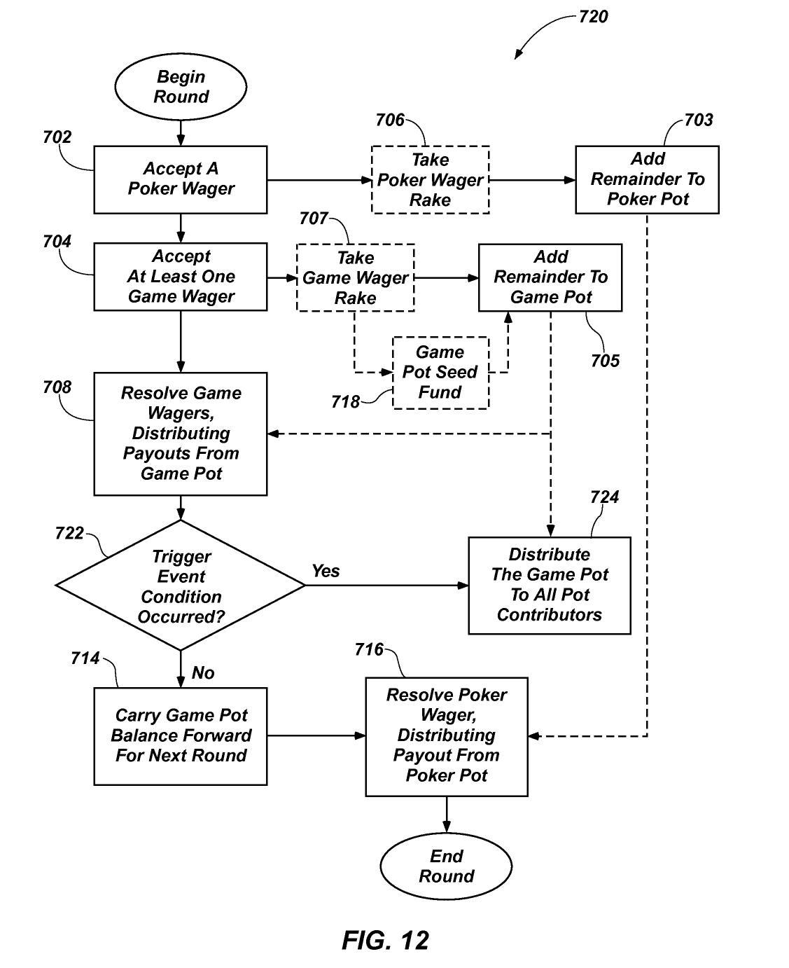

In some player-pooled embodiments, the game administrator may not obtain profits from chance-based events occurring in the wagering games that result in lost wagers. Instead, lost wagers may be redistributed back to the players. To profit from the wagering game, the game administrator may retain a commission, such as, for example, a player entrance fee or a rake taken on wagers, such that the amount obtained by the game administrator in exchange for hosting the wagering game is limited to the commission and is not based on the chance events occurring in the wagering game itself. The game administrator may also charge a rent of flat fee to participate. Specific, illustrative mechanisms for redistributing the lost wagers back to players are described in connection with FIGS. 11 and 12.

Referring to FIG. 11, shown is a flowchart diagram of a method 700 of administering a wagering game, which may be at least partially player-pooled, according to a player-pooled progressive embodiment. The method 700 includes accepting a first mandatory wager, referred to herein as a “poker wager,” as indicated at 702. At least a portion of the poker wager is added to a poker pot, as indicated at operation 703. In some embodiments, the poker wager may be later resolved by comparing player hands to one another and awarding the poker pot, or at least a portion thereof, to the player holding the highest-ranked high player hand when compared to the high player hands of the other players, the highest-ranked low player hand when compared to the low player hands of the other players, or the highest-ranked poker hand including all the cards dealt to the player when compared to the poker hand of each other player, the poker hand being composed of all the cards dealt to the respective player.

In other embodiments, the poker wager may be resolved by comparing the player hands to the dealer hands and comparing the player hands to one another. For example, the poker pot, or at least a portion thereof, may be awarded to the player whose high player hand outranks a high dealer hand, whose low player hand outranks a low dealer hand, and whose high player hand outranks the high player hand of each other player, the high player hand of whom also outranks the high dealer hand and the low player hand of whom also outranks the low dealer hand. In other words, a player may win by outranking both dealer hands and holding a highest-ranked high player hand of any player who also outranks both dealer hands. As another example, the poker pot, or at least a portion thereof, may be awarded to the player whose high player hand outranks a high dealer hand, whose low player hand outranks a low dealer hand, and whose low player hand outranks the low player hand of each other player, the high player hand of whom also outranks the high dealer hand and the low player hand of whom also outranks the low dealer hand. In other words, a player may win by outranking both dealer hands and holding a highest-ranked low player hand of any player who also outranks both dealer hands. As yet another example, the poker pot, or at least a portion thereof, may be awarded to the player whose high player hand outranks a high dealer hand, whose low player hand outranks a low dealer hand, and whose poker hand composed of all cards dealt to the player outranks the poker hand composed of all cards dealt respectively to each other player, the high player hand of whom also outranks the high dealer hand and the low player hand of whom also outranks the low dealer hand. In other words, a player may win by outranking both dealer hands and holding a highest-ranked poker hand composed of all cards dealt to the respective player when compared to any player who also outranks both dealer hands.

The poker pot may be a nonprogressive pot; more specifically, all or substantially all of the poker pot may be distributed at the conclusion of each round of the wagering game. In some embodiments, the poker wager may be a mandatory wager to qualify the player for play of the underlying wagering game. In other embodiments, the poker wager may be optional, and the wagering game may be administered to a player without receiving the poker wager and without qualifying the player for a potential payout from the poker pot.

At least one game wager may also be accepted, as indicated at 704. The game wagers may include, for example, base game wagers (e.g., ante wagers, blind wagers, play wagers, raises, and other wagers made on the underlying wagering game), side wagers, or both. More specifically, the game wagers may comprise, for example, the ante wager, the play wager, and the side wager described previously in connection with FIG. 1. At least a portion of each game wager is added to a game pot, as indicated at operation 705, which game pot may be a progressive pot.

In some embodiments, acceptance of the at least one game wager qualifies a player to be eligible to win an award in addition to the payouts available from the underlying game (i.e., the payouts on the ante, play, and side wagers described previously in connection with FIG. 1), such as, for example, a progressive payout (e.g., a progressive jackpot awarded to one or more qualifying players). Therefore, in some such embodiments, a progressive wager may be received, in addition to the other game wagers received from the player, such as any of the ante, play, and side wagers described previously in connection with FIG. 1. In other such embodiments, one of the game wagers may be converted to a progressive wager, such as, for example, any of the ante, play, and side wagers described previously in connection with FIG. 1. In some embodiments, the progressive wager may be a mandatory wager to qualify the player for play of the underlying wagering game. In other embodiments, the progressive wager may be optional, and the wagering game may be administered to a player without receiving the progressive wager, in addition to any other game wagers, from the player and without qualifying the player to be eligible to win the progressive payout from the game pot.

In some embodiments, the poker wager and the at least one game wager may be received as indistinct wagers, with a portion thereof being designated for the poker pot (a nonprogressive pot) and another portion being designated for the game pot (a progressive pot).

In some embodiments, the game pot may be a pooled or linked pot. For example, the game pot may include one or more game wagers accepted from multiple concurrent wagering games. As another example, the game pot may include pooled progressive wagers from those wagering games currently being played and may include accumulated game wagers from past wagering games. As specific, nonlimiting examples, the game pot may include all game wagers accepted from a group of electronic gaming tables or other local wagering game administration devices at a casino, from multiple groups of remote devices connected to network gaming architecture, or both. In other embodiments, the game pot may not be pooled, and awards for the game wager may be limited to the amounts wagered at a respective electronic gaming table, other local wagering game administration device, or group of remote devices.

The game administrator may take a “rake” (e.g., a commission for the house) on at least one wager, such as the poker wager, as indicated at operation 706, the at least one game wager, as indicated at operation 707, or both. In some embodiments, therefore, a rake may be taken on all wagers, or any wager. For example, the house may collect a portion of the poker wager at the time the poker wager is placed. Additionally or alternatively, the house may collect a portion of the game wagers at the time the game wagers are placed.

The rake may be, for example, a fixed percentage of the wagers. More specifically, the percentage of the wagers collected for the rake may be, for example, greater than a theoretical house advantage for the underlying game. As another example, the rake may be less than an average house advantage for play of the wagering game by all players, including average and sub-average players, which may be calculated using a historical house advantage for the wagering game (e.g., a house advantage for the wagering game over the last 5, 10, or 15 years for a given casino or other gaming establishment). As specific, nonlimiting examples, the percentage of the wagers (i.e., either or both of the poker wager and the at least one game wager) collected for the rake may be between 3% and 8%, between 4% and 7%, or between 5% and 6%. In other embodiments, the portion of the wagers collected for the rake may be a variable percentage of the wagers or may be a fixed quantity (e.g., a flat fee) irrespective of the total amount for the wagers, a fixed percentage with a cap, or a time-based fee for increments of time playing the wagering game. Thus, in lieu of, or in addition to, a rake taken on one or more wagers, the house may be compensated in a number of other ways, including, without limitation, a flat fee per round of play, a percentage of wagers made with or without a cap, rental of a player “seat,” or otherwise as is known in the gaming art. All such compensation may be generally referred to as a “commission.”

All profits for the house may be made from the rake (or rakes or other commission) in some player-banked embodiments. In such embodiments, wagered amounts in excess of the rake are distributed either in the form of, for example, a progressive payout (as in a “player-pooled progressive” embodiment (FIG. 11)), a dividend refund (as in a “dividend refund” embodiment (FIG. 12)), or some combination thereof. Thus, the profits for the house may be limited. Such limiting of profits for the house and redistribution of wagers back to one or more players may increase the attractiveness of the wagering game to both inexperienced and highly skilled players. Because the amount earned by the house is known, highly skilled players may perceive that their skill will enable them to increase winnings, and inexperienced players may be enticed by the possibility of winning or otherwise earning a portion or all of one or more of the pots. In other embodiments, the house may make profits on the rake and on losses from one or more of the wagers (e.g., the ante, play, and side wagers described previously in connection with FIG. 1), including losses resulting from optimal and suboptimal play.

The rake may be maintained in a rake account, and profits for the house may be deducted from the rake account. When and if taken from the poker wagers, the poker wager rake (operation 706) may be taken by, for example, electronically transferring funds from the poker wagers to a poker pot rake account (e.g., as instructed by a game service 616 (see FIG. 8) using casino account servers 632 (see FIG. 8)). Likewise, when and if taken from the game wagers, the game wager rake (operation 707) may be taken by, e.g., electronically transferring funds from the game pot wagers to a game pot rake account (e.g., as instructed by the game service 616 (see FIG. 8) using casino account servers 632 (see FIG. 8)).

In some embodiments, the poker wager may be accepted (operation 702) at the beginning of a round of administration of the wagering game. One or more of the game wagers may be accepted (operation 704) at the beginning of the round as well, e.g., the ante and play wagers described previously in connection with FIG. 1. In some embodiments, additional game wagers may be accepted (operation 704), possibly raked (operation 707), and added to the game pot (operation 705) in the intermediate segments of the round of play, e.g., the play wager described previously in connection with FIG. 1.

The underlying wagering game may be played as described above, including resolving the game wagers received during the round of play, as indicated at operation 708. For example, the underlying wagering game may be played at least substantially as described previously in connection with FIGS. 1 through 3. In some embodiments, rather than comparing each individual high player hand and low player hand to a corresponding high dealer hand and a corresponding low dealer hand, the individual player hands may be compared to one another, and the only hand eligible to win the ante and play wagers may be, for example, the highest-ranked high player hand, the highest-ranked low player hand, or the highest-ranked poker hand including all the cards dealt to the respective player. In other embodiments, cards may still be dealt to the dealer, and a high dealer hand and a low dealer hand may be formed from those cards according to the house way, even though the ante and play wagers are not played against the house. Payouts to be distributed, as a result of resolving the game wagers, (e.g., the payouts associated with the ante, play, and side wagers described previously in connection with FIG. 1), are paid from the game pot.

It is contemplated that only a portion of the game pot may be distributed, at operation 706, in the form of payouts on the underlying game. At least in embodiments in which the game pot is configured as a progressive pot (e.g., if one of the game wagers is a progressive wager or one game outcome of a low frequency pays the amount of the pot), all or substantially all of the remaining portion of the game pot may be designated for a potential progressive payout. For example, administering the player-pooled progressive embodiment of the player-pooled wagering game may include determining whether a progressive-winning condition has occurred, as indicated at operation 710. A progressive-winning condition may be predefined as a predetermined winning hand combination being dealt, which may result in an award of, for example, a portion of the game pot, or a premium winning hand composition being dealt, which may result in an award of, for example, an entire amount of the game pot. If such a progressive-winning condition has occurred during the round of game administration, a progressive payout may be awarded to the winning-hand-holding player, with the progressive payout being paid from the game pot, as indicated at operation 712.

As one example, a game may pay a progressive payout for holding a high player hand that outranks a high dealer hand, a low player hand that outranks a low dealer hand, and a high player hand that outranks the high player hand of each other player, the high player hand of whom also outranks the high dealer hand and the low player hand of whom also outranks the low dealer hand. As another example, the game may pay a progressive payout for holding a high player hand that outranks a high dealer hand, a low player hand that outranks a low dealer hand, and a low player hand that outranks the low player hand of each other player, the high player hand of whom also outranks the high dealer hand and the low player hand of whom also outranks the low dealer hand. As yet another example, the game may pay a progressive payout for holding a high player hand that outranks a high dealer hand, a low player hand outranks a low dealer hand, and a poker hand composed of all cards dealt to the player that outranks the poker hand composed of all cards dealt respectively to each other player, the high player hand of whom also outranks the high dealer hand and the low player hand of whom also outranks the low dealer hand.

If no progressive-winning condition has occurred, a progressive payout may not be paid from the game pot, but, rather, the game pot balance may be carried forward for the next round of play and so on, as indicated at operation 714, until a progressive-winning condition occurs during a subsequent round. Thus, the game pot may not be awarded at the end of each round of play, but may grow during each successive round in which no player is dealt a predetermined winning hand combination or a premium winning hand composition. However, if the underlying game payouts distributed at operation 708, or if a progressive payout is awarded at operation 712, without draining the game pot, the game pot may decrement until the game pot contributions, at operation 705, rebuild the game pot.

A predetermined winning hand combination may be, for example, a four-of-a-kind, a full house, a flush, a straight, a three-of-a-kind, two pair, or one pair. The hands qualifying as new winning hand combinations may be predetermined at the beginning of each round of play in some embodiments. In other embodiments, new winning hand combinations may be predetermined at the beginning of play and may remain fixed until it is determined that at least one player hand achieves a predetermined winning hand combination, at which time new winning hand combinations may be predetermined. In still other embodiments, the hand combinations qualifying as winning hand combinations may be predetermined at the outset of the wagering game and remain fixed for the duration of the wagering game. The hands qualifying as winning hand combinations may be predetermined at random from a list of possible winning hand combinations, from among a schedule with a fixed rotation of possible winning hand combinations, or using a fixed table of winning hand combinations.

A premium winning hand composition may be, for example, a four-of-a-kind, a straight flush, or a royal flush. The hand compositions qualifying as premium winning hand compositions may remain fixed throughout the duration of the wagering game or may change during the wagering game. For example, after it has been determined that a player hand has achieved a premium winning hand composition, the hand compositions qualifying as premium winning hand compositions may be made more restrictive or less restrictive. As a specific, nonlimiting example, after identification of a player hand achieving a straight flush, the hand compositions qualifying as premium winning hand compositions may be restricted to royal flushes or may be expanded to include four-of-a-kinds. The hands qualifying as premium winning hand compositions may be predetermined at random from a list of possible premium winning hand compositions, following a schedule with a fixed rotation of possible premium winning hand compositions, or according to a fixed table of premium winning hand compositions.

In embodiments in which the game pot is a progressive pot, the amount awarded from the game pot for achieving a premium winning hand composition may be a progressive payout at least as great as a maximum progressive payout for achieving a predetermined winning hand composition. For example, the entire game pot may be awarded when a player or multiple players are dealt a premium winning hand composition, and only a portion of the game pot may be awarded when a player or multiple players are dealt a predetermined winning hand combination.

Awarding the game pot or a portion of the game pot may involve crediting a player account with funds from the game pot or may comprise distributing physical money or physical representations of money from the game pot to the player.

Before, between, or after resolving the game wagers (operation 708), determining whether a progressive-winning condition occurred (operation 710), awarding a progressive payout (operation 712), or any combination thereof, the poker wager may be resolved, and the poker pot may be awarded to at least one player, as indicated at operation 716. Each successive round of receiving wagers, dealing cards, and resolving wagers may constitute a round of play, and the poker pot may be awarded to at least one player before the end of each round of play. The player to whom the poker pot is awarded may hold a high player hand that outranks a high dealer hand, a low player hand that outranks a low dealer hand, and a high player hand that outranks the high player hand of each other player, the high player hand of whom also outranks the high dealer hand and the low player hand of whom also outranks the low dealer hand. As another example, the player to whom the poker pot is awarded may hold a high player hand that outranks a high dealer hand, a low player hand that outranks a low dealer hand, and a low player hand that outranks the low player hand of each other player, the high player hand of whom also outranks the high dealer hand and the low player hand of whom also outranks the low dealer hand. As yet another example, the player to whom the poker pot is awarded may hold a high player hand that outranks a high dealer hand, a low player hand outranks a low dealer hand, and a poker hand composed of all cards dealt to the player that outranks the poker hand composed of all cards dealt respectively to each other player, the high player hand of whom also outranks the high dealer hand and the low player hand of whom also outranks the low dealer hand.

Awarding the poker pot or the portion of the poker pot may involve crediting a player account of each winning player or may comprise distributing physical money or physical representations of money to each winning player.

In some embodiments, an entire amount of the poker pot may be awarded to at least one player before the end of each round of play. In such embodiments, the poker pot may be a nonprogressive pot. Awarding the entire amount of a poker pot to at least one player at the end of each round of play redistributes lost poker wagers attributable to suboptimal play to other players, rather than to the house.

In some embodiments involving a no-house-advantage poker pot awarded at the end of each round and a progressive game pot that receives all other game wagers, all players participating in the wagering game from whom the at least one game wager has been received may be eligible to win the game pot or a portion of the game pot. Players who are ineligible to win the poker pot, and players from whom fold indications have been received but from whom one or more other active wagers in play have been received, may be eligible to win the game pot or a portion of the game pot.

In some embodiments, the game pot may be seeded with money from the game pot rake account or a reserve account (as indicated at operation 718) at the beginning of play, after the game pot or a portion of the game pot has been awarded, or both. In some embodiments, a minimum account balance sufficient to cover expected losses is retained when distributing a progressive payout (operation 712) such that no seed money is required in the game pot. For example, the game pot may be seeded from the rake account of the house (operation 718), and the house may maintain an amount of funds in the rake account sufficient to significantly reduce (e.g., to essentially eliminate) the likelihood that any payouts made from the rake account and any seeding amounts withdrawn from the rake account exhaust or overdraw the rake account. In some embodiments, a casino reserve account may be provided to fill the rake account in the event of an overdraw. Such seeding may incentivize players to participate in the wagering game, and specifically to place a game wager (e.g., a progressive wager) to be eligible for the progressive payout from the game pot. In addition, such seeding may reduce the likelihood that the amount of funds in the game pot may be insufficient to cover all the payouts to players. For example, where a player hand achieves a premium winning hand composition in one round of play, a player hand achieves a predetermined winning hand combination in the immediately following round of play, and a fixed-odds payout is to be awarded to the player holding the predetermined winning hand combination, the amount seeded to the game pot between those rounds of play may be at least as great as the maximum fixed-odds payout awardable for any predetermined winning hand combination. The game pot may be seeded each time the game pot is awarded in its entirety or each time the amount in the game pot is lower than the maximum fixed-odds payout.

FIG. 12 is a flowchart diagram of a method 720 of administering a wagering game, which may be at least partially player-pooled, according to a dividend refund embodiment. The method 720 is largely the same as the method 700 of the player-pooled progressive (FIG. 11), with the exception that, rather than determining whether a progressive-winning condition has occurred (operation 710 (FIG. 11)), the method 720 includes determining whether a trigger event condition has occurred, as indicated at operation 722, and, if so, distributing the game pot to one or more past or present players of the wagering game, as indicated at operation 724 (rather than distributing the game pot as a progressive payout as at operation 712 (FIG. 11)). In such embodiment, the game pot may accumulate between rounds of play, and, to periodically reduce the balance, a dividend (e.g., a share of the game pot awarded to each participating player) may be awarded to players from the game pot. Thus, what would otherwise be the profits from lost wagers, less amounts raked by the house, are redistributed back to the players, rather than collected by the house as revenue. Thus, the distribution is not a payout on the underlying game, but a refund.

The game pot may be distributed among a plurality of players upon the occurrence of a predetermined event (referred to herein as a “trigger event”), as indicated at operation 722. The predetermined, trigger event may not be based, for example, on player skill or chance events occurring in the underlying wagering game. The predetermined trigger event may comprise, for example, determination that at least one player participated for a predetermined number of hands; completed a predetermined number of rounds of play at a given table, electronic gaming machine, or remote gaming device; reached a predetermined time limit since play commenced; or reached a predetermined amount within the game pot. The predetermined trigger event or condition may be time-based, pot-based (or pool-based), game-based, amount-based, or other-based. Further details on pot distributions based on predetermined trigger events and conditions are disclosed in the U.S. patent application Ser. No. 13/871,824, filed Apr. 26, 2013, titled “DISTRIBUTING SUPPLEMENTAL POT IN WAGERING GAMES BASED ON PREDETERMINED EVENT,” the disclosure of which is incorporated herein in its entirety by this reference.

The dividend distributions may be divided at least among players currently participating in the wagering game. In some embodiments, the dividend distributions may also be paid to players who previously contributed to the game pot but who have since ceased participating in the wagering game. In some embodiments, the dividend distributions may not be paid to players from whom contributions to the game pot have not been received since the last dividend distribution was paid. The percentage of the game pot refunded to each player as a dividend distribution may be, for example, approximately equal to the percentage of hands won by each player, the percentage of first pot winnings won by each player based on game play, the percentage of total wager amounts received from each player, the proportional number of wagers received from each player, the proportional length of time spent playing the wagering game by each player, or an equal percentage for each player eligible to receive a dividend distribution from the game pot.

The dividend refund may be distributed in the form of a credit made to the receiving players' accounts. In some embodiments, the refund may be paid without concurrently alerting the player, though the refund may be noticeable when and if the player next checks his or her balance in his or her player account.

In some embodiments, wagering games may be administered without players risking money in connection with the wagers (i.e., “play-for-fun” games). Access to play-for-fun wagering games may be granted on a time period basis in some embodiments. For example, upon initially joining the wagering game, each player may automatically be given nonmonetary wagering elements, such as, for example, chips, points, or simulated currency, that are of no redeemable value. After joining, the player may be permitted to place bets using the wagering elements and a timer may track how long the player has been participating in the wagering game. If the player exhausts his or her supply of the wagering elements before a predetermined period of time has expired, the player may be permitted to simply wait until the period of time passes to rejoin the game, at which time access to another quantity of the wagering elements may be granted to the player to permit the player to resume participation in the wagering game.

In some embodiments, a hierarchy of players may determine the quantity of wagering elements given to a player for each predetermined period of time. For example, players who have been participating in the wagering game for a longer time, who have played closest to optimal strategy for the game, who have won the largest percentage of wagers, who have wagered the most in a play-for-pay environment, or who have won the largest quantities of wagering elements from their wagers may be given more wagering elements for each allotment of time than players who have newly joined, who have played according to poor strategy, who have lost more frequently, or who have lost larger quantities of wagering elements. In some embodiments, the hierarchy of players may determine the duration of each allotment of time. For example, players who have been participating in the wagering game for a longer time, who have played closest to optimal strategy for the game, who have won the largest percentage of wagers, or who have won the largest quantities of wagering elements from their wagers may be given shorter allotments of times to wait for an award of more wagering elements than players who have newly joined, who have played according to poor strategy, who have lost more frequently, or who have lost larger quantities of wagering elements. In some embodiments, players who have not run out of wagering elements after the period of time has expired may have the balance of their wagering elements reset for a subsequent allotment of time. In other embodiments, players who have not run out of wagering elements may be allowed to retain their remaining wagering elements for subsequent allotments of time, and may be given additional wagering elements corresponding to the new allotment of time to further increase the balance of wagering elements at their disposal. Players may be assigned to different categories of players, which determine the number of wagering elements awarded. In a given period of time, higher level players, or players who have invested more time playing the game may be allotted more wagering elements per unit of time than a player assigned to a lower level group.

Therefore, in some embodiments, the wagering game may be administered by receiving wagers (e.g., the ante, play, and side wagers described previously in connection with FIG. 1) of no real-world monetary value, and payouts (e.g., the payouts associated with the ante, play, and side wagers described previously in connection with FIG. 1) may be paid without transferring real-world monetary value to the players. Such embodiments, referred to herein as “free play-for-fun” embodiments are nonetheless contemplated as modes of carrying out the methods described herein.

In some embodiments, referred to herein as “social play-for-fun” embodiments, a player may be permitted to redeem an access token of no redeemable face value, such as, for example, points associated with a player account (e.g., social media account credits, online points associated with a transacting account, etc.), to compress the period of time and receive more wagering elements. The access tokens may be sold or may be given without directly exchanging money for the access tokens. For example, access tokens may be allocated to players who participate in member events (e.g., complete surveys, receive training on how to play the wagering game, share information about the wagering game with others), spend time participating in the wagering game or in a player account forum (e.g., logged in to a social media account), or view advertising. Thus, an entity administering social play-for-fun wagering games may not receive money from losing player wagers or may not take a rake on wagers, but may receive compensation through advertising revenue or through the purchase of access tokens redeemable for time compressions to continue play of the wagering game or simply to increase the quantity of wagering elements available to a player.

After receipt of an indication that a player has stopped participating in a play-for-fun wagering game (e.g., a free play-for-fun embodiment, a social play-for-fun embodiment), any remaining quantities of the wagering elements may be relinquished by the player and retained by the administrator, in some embodiments. For example, receipt of an indication that the player has logged out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, upon receipt of an indication that a player has stopped playing, the quantity of wagering elements held by the player at that time may be retained and made available to the player, along with any additional quantities of wagering elements granted for new allotments of time, upon receipt of an indication that the player has rejoined the wagering game.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being within the scope of the disclosure, as contemplated by the inventor.

1. A method of administering a wagering game, comprising:
accepting an ante wager from a player to play a wagering game against a dealer by receiving a physical, monetarily valuable wagering element in a designated area on a surface of a gaming table;
dealing cards from a set of randomized, physical cards comprising at least one deck of at least 52 standard playing cards to the player and to the dealer;
accepting the player's arrangement of the cards dealt to the player into a high player hand and a low player hand or arranging the cards dealt to the player into a high player hand and a low player hand;
arranging the cards dealt to the dealer into a high dealer hand and a low dealer hand;
resolving the ante wager by comparing the high player hand to the high dealer hand and the low player hand to the low dealer hand;
collecting an amount of the ante wager when one of the high player hand and the low player hand is of the same rank as a corresponding one of the high dealer hand and the low dealer hand, respectively, and the other of the high player hand and the low player hand is of a different rank than a corresponding other of the high dealer hand and the low dealer hand, respectively, by retrieving each wagering element associated with the ante wager of the player from the surface of the gaming table; and
paying a payout on the ante wager to the player when the high player hand is of a same rank as the high dealer hand and the low player hand is of the same rank as the low dealer hand by transferring at least one additional physical, monetarily valuable wagering element to the player.

2. The method of claim 1, further comprising:
paying a payout on the ante wager to the player when the high player hand outranks the high dealer hand and the low player hand outranks the low dealer hand by transferring at least one additional physical, monetarily valuable wagering element to the player;
returning the amount of the ante wager to the player when one of the high player hand and the low player hand outranks a corresponding one of the high dealer hand and the low dealer hand, respectively, and the other of the high player hand and the low player hand is outranked by a corresponding other of the high dealer hand and the low dealer hand, respectively, by physically transferring all wagering elements associated with the ante wager to the player; and
collecting the amount of the ante wager when the high player hand is outranked by the high dealer hand and the low player hand is outranked by the low dealer hand by retrieving all wagering elements associated with the ante wager of the player from the surface of the gaming table.

3. The method of claim 1, further comprising:
returning the amount of the ante wager to the player when one of the high player hand and the low player hand outranks a corresponding one of the high dealer hand and the low dealer hand, respectively, and the other of the high player hand and the low player hand is composed of cards of the same rank as cards of a corresponding other of the high dealer hand and the low dealer hand, respectively, even though the hands are of the same rank by physically transferring all wagering elements associated with the ante wager to the player; and
collecting the amount of the ante wager when the high player hand is composed of cards of the same rank as cards of the high dealer hand even though the hands are of the same rank and the low player hand is outranked by the low dealer hand or when the high player hand is outranked by the high dealer hand and the low player hand is composed of cards of the same rank as cards of the low dealer hand even though the hands are of the same rank by retrieving all wagering elements associated with the ante wager of the player from the surface of the gaming table.

4. The method of claim 1, further comprising:
returning the amount of the ante wager to the player when one of the high player hand and the low player hand outranks a corresponding one of the high dealer hand and the low dealer hand, respectively, and the other of the high player hand and the low player hand is composed of cards of the same rank as cards of a corresponding other of the high dealer hand and the low dealer hand, respectively, even though the hands are of the same rank by physically transferring all wagering elements associated with the ante wager to the player; and
returning the amount of the ante wager to the player when the high player hand is composed of cards of the same rank as cards of the high dealer hand even though the hands are of the same rank and the low player hand is outranked by the low dealer hand; when the high player hand is outranked by the high dealer hand and the low player hand is composed of cards of the same rank as cards of the low dealer hand even though the hands are of the same rank by physically transferring all wagering elements associated with the ante wager to the player.

5. The method of claim 1, wherein dealing the cards from the set of randomized, physical cards comprising at least one deck of at least 52 standard playing cards to the player and to the dealer comprises dealing the cards from a set of randomized, physical cards further including a wild card and further comprising paying a payout on the ante wager to the player when one of the high player hand and the low player hand includes the wild card by transferring at least one additional physical, monetarily valuable wagering element to the player.

6. The method of claim 1, wherein:
accepting the player's arrangement of the cards dealt to the player into the high player hand and the low player hand or arranging the cards dealt to the player into the high player hand and the low player hand comprises accepting the player's arrangement of the cards into a high player hand of no more than three cards and a low player hand of no more than three cards or arranging the cards into a high player hand of no more than three cards and a low player hand of no more than three cards; and
arranging the cards dealt to the dealer into the high dealer hand and the low dealer hand comprises arranging the cards into a high dealer hand of no more than three cards and a low dealer hand of no more than three cards.

7. The method of claim 1, wherein:
dealing the cards to the player and to the dealer comprises dealing four cards to each of the player and the dealer;
accepting the player's arrangement of the cards dealt to the player into the high player hand and the low player hand or arranging the cards dealt to the player into the high player hand and the low player hand comprises accepting the player's arrangement of the cards into a two-card high player hand and a two-card low player hand or arranging the cards into a two-card high player hand and a two-card low player hand; and
arranging the cards dealt to the dealer into the high dealer hand and the low dealer hand comprises arranging the cards into a two-card high dealer hand and a two-card low dealer hand.

8. The method of claim 7, further comprising:
receiving from the player one of the cards dealt to the player before accepting the player's arrangement of the cards into the high player hand and the low player hand or arranging the cards into the high player hand and the low player hand; and
dealing a replacement card from the set of randomized, physical cards to the player.

9. The method of claim 1, further comprising:
accepting a side wager from the player to play a side wagering game against a pay table by receiving another physical, monetarily valuable wagering element in another designated area on the surface of the gaming table;
resolving the side wager by comparing all the cards dealt to the player to the pay table;
paying a payout on the side wager to the player when the cards dealt to the player include a pair of equally ranked cards by transferring at least one additional physical, monetarily valuable wagering element to the player; and
collecting an amount of the side wager when the cards dealt to the player do not include a pair of equally ranked cards by retrieving all wagering elements associated with the ante wager of the player from the surface of the gaming table.

10. The method of claim 1, wherein:
dealing the cards to the player and to the dealer comprises dealing five randomized physical cards to each of the player and the dealer;
accepting the player's arrangement of the cards dealt to the player into the high player hand and the low player hand or arranging the cards dealt to the player into the high player hand and the low player hand comprises accepting the player's arrangement of the cards into a two-card high player hand, a two-card low player hand, and a discarded card or arranging the cards into a two-card high player hand, a two-card low player hand, and a discarded card; and
arranging the cards dealt to the dealer into the high dealer hand and the low dealer hand comprises arranging the cards into a two-card high dealer hand, a two-card low dealer hand, and a discarded card.

11. The method of claim 1, wherein dealing the cards to the dealer comprises dealing one of the cards to the dealer face up and further comprising:
accepting a play wager from the player by receiving another physical, monetarily valuable wagering element on the surface of the gaming table, responsive to which the ante wager remains in play by leaving each wagering element associated with the ante wager of the player in the designated area, or accepting a player election to fold, responsive to which each wagering element associated with the ante wager of the player is retrieved from the surface of the gaming table; and
resolving the play wager in the same way as the ante wager.

12. The method of claim 1, further comprising refraining from collecting a commission on each wager and each payout associated with the wagering game.

13. A method of administering a wagering game, comprising:
accepting an ante wager from a player to play a wagering game against a dealer by receiving a physical, monetarily valuable wagering element in a first designated area on a surface of a gaming table;
dealing cards from a set of randomized, physical card comprising at least one deck of at least 52 standard playing cards to the player and to the dealer;
accepting the player's arrangement of the cards dealt to the player into a high player hand and a low player hand or arranging the cards dealt to the player into a high player hand and a low player hand;
arranging the cards dealt to the dealer into a high dealer hand and a low dealer hand;
resolving the ante wager by comparing the high player hand to the high dealer hand and the low player hand to the low dealer hand;
paying a payout on the ante wager to the player when the high player hand outranks the high dealer hand and the low player hand outranks the low dealer hand by physically transferring wagering elements to the player;
returning an amount of the ante wager to the player when one of the high player hand and the low player hand outranks a corresponding one of the high dealer hand and the low dealer hand, respectively, and the other of the high player hand and the low player hand is outranked by a corresponding other of the high dealer hand and the low dealer hand by physically transferring all wagering elements associated with the ante wager to the player;
collecting the amount of the ante wager when the high player hand is outranked by the high dealer hand and the low player hand is outranked by the low dealer hand by retrieving all wagering elements associated with the ante wager of the player from the surface of the gaming table;
paying a payout on the ante wager to the player when the high player hand is of a same rank as the high dealer hand and the low player hand is of the same rank as the low dealer hand by transferring at least one additional physical, monetarily valuable wagering element to the player; and
collecting the amount of the ante wager when one of the high player hand and the low player hand is of the same rank as a corresponding one of the high dealer hand and the low dealer hand, respectively, and the other of the high player hand and the low player hand is of a different rank than a corresponding other of the high dealer hand and the low dealer hand, respectively, by retrieving all wagering elements associated with the ante wager of the player from the surface of the gaming table.

14. The method of claim 13, wherein dealing the cards from the set of randomized, physical cards comprising at least deck of at least 52 standard playing cards to the player and to the dealer comprises dealing the cards from a set of randomized, physical cards further including a wild card and further comprising paying a payout on the ante wager to the player when one of the high player hand and the low player hand includes the wild card by transferring at least one additional physical, monetarily valuable wagering element to the player.

15. The method of claim 13, wherein:
accepting the player's arrangement of the cards dealt to the player into the high player hand and the low player hand or arranging the cards dealt to the player into the high player hand and the low player hand comprises accepting the player's arrangement of the cards into a high player hand of no more than three cards and a low player hand of no more than three cards or arranging the cards into a high player hand of no more than three cards and a low player hand of no more than three cards; and
arranging the cards dealt to the dealer into the high dealer hand and the low dealer hand comprises arranging the cards into a high dealer hand of no more than three cards and a low dealer hand of no more than three cards.

16. The method of claim 13, wherein:
dealing the cards to the player and to the dealer comprises dealing four cards to each of the player and the dealer;
accepting the player's arrangement of the cards dealt to the player into the high player hand and the low player hand or arranging the cards dealt to the player into the high player hand and the low player hand comprises accepting the player's arrangement of the cards into a two-card high player hand and a two-card low player hand or arranging the cards into a two-card high player hand and a two-card low player hand; and
arranging the cards dealt to the dealer into the high dealer hand and the low dealer hand comprises arranging the cards into a two-card high dealer hand and a two-card low dealer hand.

17. The method of claim 16, further comprising:
receiving from the player one of the cards dealt to the player before accepting the player's arrangement of the cards into the high player hand and the low player hand or arranging the cards into the high player hand and the low player hand; and
dealing a replacement card from the set of randomized, physical cards to the player.

18. The method of claim 13, further comprising:
accepting a side wager from the player to play a side wagering game against a pay table by receiving another physical, monetarily valuable wagering element in another designated area on the surface of the gaming table;
resolving the side wager by comparing the high player hand and the low player hand to the pay table;
paying a payout on the side wager to the player when at least one of the high player hand and the low player hand includes a pair of equally ranked cards by transferring at least one additional physical, monetarily valuable wagering element to the player; and
collecting an amount of the side wager when neither the high player hand nor the low player hand includes a pair of equally ranked cards by retrieving all wagering elements associated with the ante wager of the player from the surface of the gaming table.

19. The method of claim 13, further comprising refraining from collecting a commission on each wager and each payout associated with the wagering game.

20. A method of transforming a network into a wagering game administration endpoint, comprising:
receiving at a server comprising a control circuit an electronic signal indicating that allocation of funds to an ante wager was authorized by a player to play a wagering game against dealer hands;
randomly assigning at the server rank and suit information correlating to cards from a set of cards comprising at least one deck of at least 52 standard playing cards to the player and to the dealer hands;
accepting at the server an electronic signal indicating that the player has arranged the cards assigned to the player into a high player hand and a low player hand or arranging at the server the cards dealt to the player into a high player hand and a low player hand;
arranging at the server the cards assigned to the dealer hands into a high dealer hand and a low dealer hand;
resolving the ante wager by comparing at the server the high player hand to the high dealer hand and the low player hand to the low dealer hand;
generating at the server an electronic signal indicating that collection of the amount of the ante wager is authorized when one of the high player hand and the low player hand is of the same rank as a corresponding one of the high dealer hand and the low dealer hand, respectively, and the other of the high player hand and the low player hand is of a different rank than a corresponding other of the high dealer hand and the low dealer hand, respectively; and
generating at the server an electronic signal indicating that payment of a payout to the player is authorized when the high player hand is of a same rank as the high dealer hand and the low player hand is of the same rank as the low dealer hand.

21-26. (canceled)
